(19) United States
(12) Patent Application Publication
(10) Pub. No.: US 2013/0332156 A1
(43) Pub. Date: Dec. 12, 2013

(54) Sensor Fusion to Improve Speech/Audio Processing in a Mobile Device

(71) Applicant: APPLE INC., Cupertino, CA (US)

(72) Inventors: Onur Ergin Tackin, Sunnyvale, CA (US); Sinan Karahan, Menlo Park, CA (US); Lalin S. Theverapperuma, Cupertino, CA (US); Tiange Shao, Santa Clara, CA (US); Haining Zhang, San Jose, CA (US); Arun G. Mathias, Los Altos, CA (US)

(73) Assignee: APPLE INC., Cupertino, CA (US)

(21) Appl. No.: 13/775,100

(22) Filed: Feb. 22, 2013

Related U.S. Application Data
(60) Provisional application No. 61/658,332, filed on Jun. 11, 2012.

(51) Int. Cl. H04R 29/00; G10L 21/0216

(52) U.S. Cl. CPC H04R 29/004; G10L 21/0216
USPC 704/226; 381/56

(57) ABSTRACT

The disclosed system and method for a mobile device combines information derived from onboard sensors with conventional signal processing information derived from a speech or audio signal to assist in noise and echo cancellation. In some implementations, an Angle and Distance Processing (ADP) module is employed on a mobile device and configured to provide runtime angle and distance information to an adaptive beamformer for canceling noise signals, provides a means for building a table of filter coefficients for adaptive filters used in echo cancellation, provides faster and more accurate Automatic Gain Control (AGC), provides delay information for a classifier in a Voice Activity Detector (VAD), provides a means for automatic switching between a speakerphone and handset mode of the mobile device, or primary microphone and reference microphones and assists in separating echo path changes from double talk.

### CROSS-REFERENCE TO RELATED APPLICATION

This application claims priority to U.S. Provisional Application No. 61/658,332, entitled “Sensor Fusion to Improve Speech/Audio Processing in a Mobile Device,” filed on Jun. 11, 2012, the entire contents of which are incorporated herein by reference.

### TECHNICAL FIELD

The subject matter of this application is generally related to speech/audio processing.

### BACKGROUND

Conventional noise and echo cancellation techniques employ a variety of estimation and adaptation techniques to improve voice quality. These conventional techniques, such as fixed beamforming and echo canceling, assume that no a priori information is available and often rely on the signals alone to perform noise or echo cancellation. These estimation techniques also rely on mathematical models that are based on assumptions about operating environments. For example, an echo cancellation algorithm may include an adaptive filter that requires coefficients, which are selected to provide adequate performance in some operating environments but may be suboptimal for other operating environments. Likewise, a conventional fixed beamformer for canceling noise signals cannot dynamically track changes in the orientation of a speaker's mouth relative to a microphone, making the conventional fixed beamformer unsuitable for use with mobile handsets.

### SUMMARY

The disclosed system and method for a mobile device combines information derived from onboard sensors with conventional signal processing information derived from a speech or audio signal to assist in noise and echo cancellation. In some implementations, an Angle and Distance Processing (ADP) module is employed on a mobile device and configured to provide runtime angle and distance information to an adaptive beamformer for canceling noise signals. In some implementations, the ADP module create tables with position information and indexing the corresponding adaptive filter coefficient sets for beamforming, echo cancellation, and echo canceller double talk detection. Changing of adaptive filter coefficients with these preset coefficients enable the use of smaller adaptation rate, which in turn improve the stability and convergence speed of the echo canceller and beamformer performance. In some implementations, the ADP module provides faster and more accurate Automatic Gain Control (AGC). In some implementations, the ADP module provides delay information for a classifier in a Voice Activity Detector (VAD). In some implementations, the ADP module provides a means for automatic switching between a speakerphone and handset mode of the mobile device. In some implementations, ADP based double talk detection is used to separate movement based echo path changes from near end speech. In some implementations, the ADP module provides means for switching microphone configurations suited for noise cancellation, microphone selection, dereverberation and movement scenario based signal processing algorithm selection.

### DESCRIPTION OF DRAWINGS

FIG. 1 illustrates an exemplary operating environment for a mobile device employing an ADP module for assisting in noise and echo cancellation.

FIG. 2 is a block diagram of an example echo and noise cancellation system assisted by an ADP module.

FIG. 3 is a block diagram of an example gain calculation system assisted by an ADP module.

FIG. 4 is a block diagram of an example adaptive MVRD beamformer assisted by an ADP module.

FIG. 5 is a block diagram of an example system for automatic switching between a speakerphone mode and a handset mode.

FIG. 6 is a block diagram of an example VAD for detecting voice activity assisted by an ADP module.

FIG. 7 is a flow diagram of an example process that uses sensor fusion to perform echo and noise cancellation.

FIG. 8 is a block diagram of an example architecture for a device that employs sensor fusion for improving noise and echo cancellation.

FIG. 9 is a block diagram of example ADP module internal process.

FIG. 10 shows an example of the table mapping used by the ADP module.

FIG. 11 is a plot illustrating echo path and change of echo path with changes of the position, detected by the ADT module.

FIG. 12 is a block diagram of an example ADP module based LCMV/TF-GSC beamformer.

FIG. 13 is a diagram illustrating an example beam pattern for a MVDR beamformer.

FIGS. 14A and 14B illustrate an exemplary method of calculating the position of microphone 1 and microphone 2 in Ear Reference Coordinates (ERC).

FIG. 15 illustrates three frame coordinates used in the ADP process based on a rotation matrix.

FIG. 16 illustrates a rotation between two world frame coordinate systems.

FIG. 17 illustrates a transformation from the world frame coordinate system to the EAR frame coordinate system.

FIG. 18 illustrates an angle a line vector makes with a plane.

FIG. 19 illustrates a tilt angle of the mobile device.

FIG. 20 illustrates a rotation angle of the mobile device.

FIG. 21 illustrates a local geometry of microphones on the mobile device.

FIG. 22 illustrates a complete human-phone system and a final calculation of the distance from mouth to microphones.

### DETAILED DESCRIPTION

### Example Operating Environment

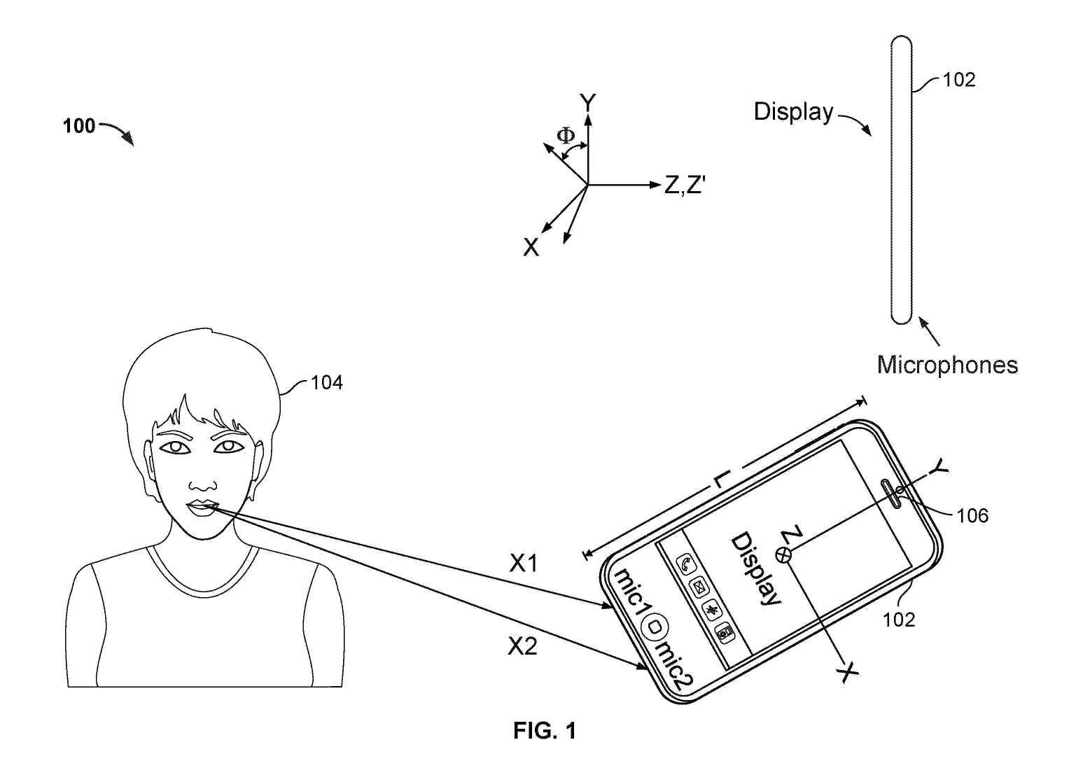

FIG. 1 illustrates an exemplary operating environment 100 for a mobile device 102 employing an ADP module for assisting in noise and echo cancellation or other speech processing tasks. Environment 100 can be any location where user 104 operates mobile device 102. In the depicted example, user 104 operates mobile device 102 to access cellular services, WiFi services, or other wireless communication networks. Environment 100 depicts user 104 operating mobile device 102 in handset mode. In handset mode, user 104 places mobile device 102 to an ear and engages in a phone call or voice activated service. Mobile device 102 can be, for example, a mobile phone, a voice recorder, a game console, a portable computer, a media player or any other mobile device that is capable of processing input speech signals or other audio signals.

Mobile device 102 can include a number of onboard sensors, including but not limited to one or more of a gyroscope, an accelerometer, a proximity sensor and a microphones. The gyroscope and accelerometer can each be a micro-electrical-mechanical system (MEMS). The sensors can be implemented in a single integrated circuit or the same integrated circuit. The gyroscope (hereafter “gyro”) can be used to determine an incident angle of a speech or other audio source during runtime of mobile device 102. The incident angle defines an orientation of one or more microphones of mobile device 102 to a speech/audio signal source, which in this example is the mouth of user 104.

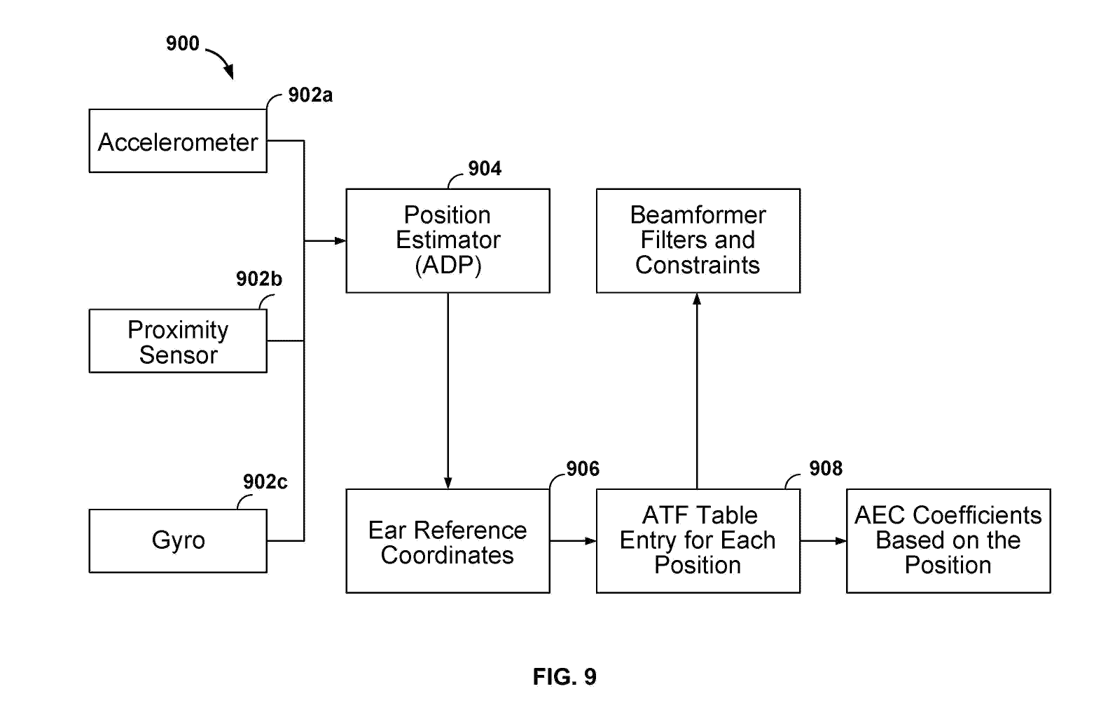

FIG. 9 is a block diagram of an internal process of the ADP module. When a telephone conversation is initiated, or answering an incoming telephone call, the mobile device is brought near the ear. When a mobile device is placed on the ear, proximity sensor 902b reaches its maximum activation. At this time instance, position estimator 904 resets ERC system 906 to the origin. Position estimator 904 can use a spherical or Cartesian coordinate system. Successive movements can be estimated using integrated gyro data from gyro sensor 902c and double integrated accelerometer data from accelerometer sensor 902a.

In some implementations, gyro sensor 902c internally converts angular velocity data into angular positions. The coordinate system used by gyro sensor 902c can be rotational coordinates, commonly in quaternion form (scalar element and three orthogonal vector elements):

Q=<w,v>, (1)

where w is a scalar,

v=xi+yj+zk and

\sqrt{x²+y²+z²+w²}=1. (2)

A rotation of the mobile device by an angle θ about an arbitrary axis pointing in u direction can be written as,

Qᵤ=<wᵤ, vᵤ> (3)

where

w=cos θ/2

vᵤ=u·sin θ/2

From the initial position of the ERC origin P₀=<0, 0, 0>, the position of the mobile device after successive rotations with quaternions Qₚ₁, Qₚ₂, . . . , Qₚₙ, can be given by P₁, . . . , Pₙ. The coordinates of each of these rotated positions in 3D space can be given as

P₁=Qₚ₁·P₀·Qₚ₁⁻¹, where (4)

Qₚ₁⁻¹ is the inverse of the quaternion Qₚ₁.

Attitude information of the mobile device can be continually calculated using Qₚ while the mobile device is in motion. ADP module 206 combines the rotation measured on its internal reference frame with the movements measured by accelerometer sensor 902a and generates relative movements in ERC. Velocity and position integrations can be calculated on a frame-by-frame basis by combining the quaternion output of gyro sensor 902c with the accelerometer data from accelerometer sensor 902a.

In some implementations, the accelerometer data can be separated into moving and stopped segments. This segmenting can be based on zero acceleration detection. At velocity zero positions, accelerometer offsets can be removed. Only moving segments are used in integrations to generate velocity data. This segmenting reduces the accelerometer bias and longtime integration errors. Velocity data is again integrated to generate position. Since the position and velocity are referenced to the mobile device reference frame, they are converted to ERC at the ADP module 206. Acceleration at time n can be written as

Aₙ=<aₓ, a_{y}, a_{z}>. (5)

Velocity for a smaller segment can be generated by

$$\begin{matrix}{V}_{n} = {\sum }_{t 1}^{tn} {A}_{n} - correction factor & ( 6 ) \\ {V}_{n} = 〈 {v}_{x} , {v}_{y} , {v}_{z} 〉 . & ( 7 )\end{matrix}$$

The position P_{N} after this movement can be given by

$$\begin{matrix}{P}_{n} = {\sum }_{t 1}^{tn} {V}_{n} & ( 8 ) \\ {P}_{n} = 〈 {p}_{x} , {p}_{y} , {p}_{z} 〉 . & ( 9 )\end{matrix}$$

The correction factor removes the gravity associated error and other accelerometer bias. Further calibrating of the mobile device with repeated movements before its usage can reduce this error.

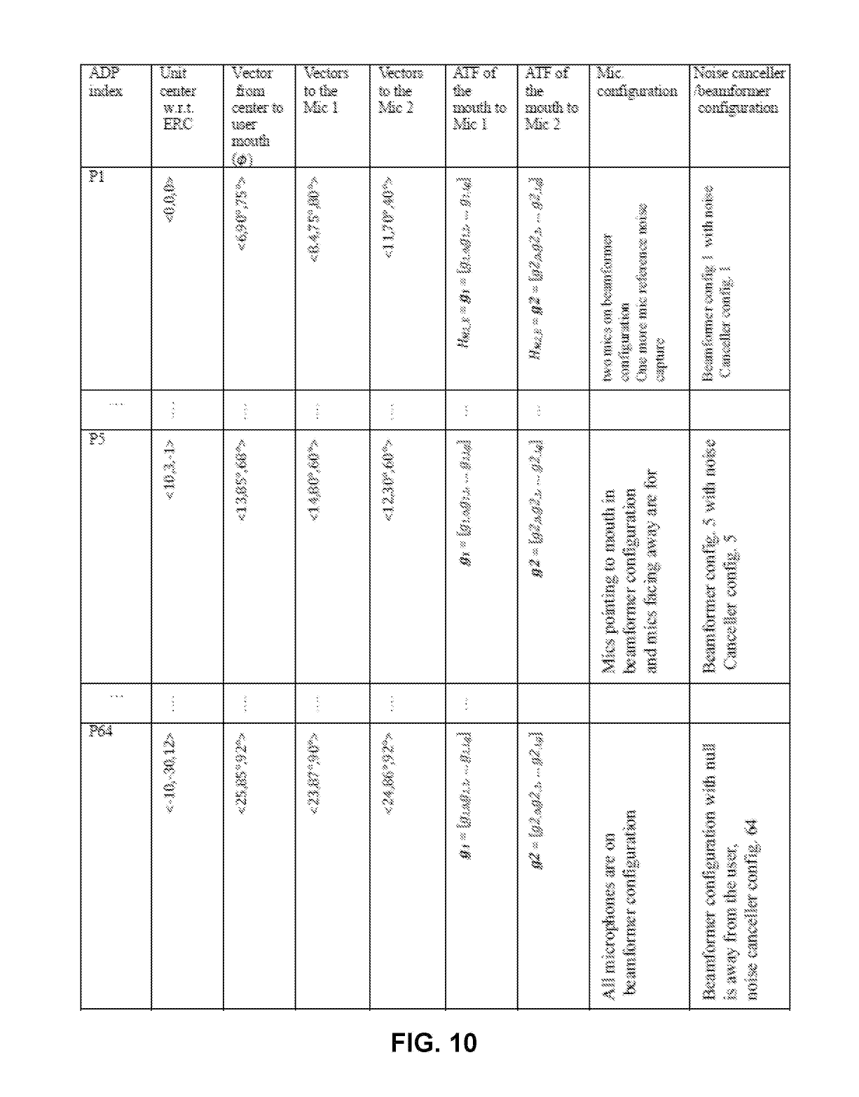

FIGS. 9 and 10 illustrate table mapping used by the ADP module 206. Referring to FIG. 9, table 908 can be used to map position information with prerecorded Acoustic Transfer Functions (ATF) used for beamforming, microphone configurations, noise canceller techniques, AEC and other signal processing methods. Table 908 and position entries can be created for a typical user. In some implementations, calibration can be performed using HATs or KEMAR mannequins during manufacturing.

In some implementations, during the calibration phase, table 908 of potential positions P₁, . . . , P_{N} inside the usage space can be identified and their coordinates relative to the ERC origin can be tabulated along with the other position related information in the ADP module 206.

When a user moves the mobile device, position estimator 904 computes the movement trajectory and arrives at position information. This position information can be compared against the closest matching position on the ADP position table 908. Once the position of the mobile device is identified in ERC, the ADP module 206 can provide corresponding beamforming filter coefficients, AEC coefficients, AGC parameters, and VAD parameters to the audio signal-processing module.

In some implementations, the initial orientation of the mobile device can be identified with respect to the user of the mobile device using the quaternion before it reaches the reset position and the gravity vector g=<0, 0, −1> at the reset position. The gravity vector with respect to the mobile device can be written as <x_{z}, y_{z}, z_{z}>. A unit vector pointing to the direction of the gravity quaternion and the quaternion at the reset instance is Qₒ=<w₀, x₀i+y₀j+z₀k> can be rotated to the direction of gravity vector, which results in

x_{z}=[(w₀·2y₀)−(x₀·2z₀)]

y_{z}=[−(w₀·2x₀)−(y₀·2z₀)]

z_{z}=[(x₀·2x₀)+(y₀·2y₀)−1.0] (10)

The above vector points to the direction of gravity, or in normal usage downwards. By combining the above gravity direction unit vector along with a given mobile device dimensions, and prior mouth to ear dimensions of a typical user, distances from mouth to microphone 1 and microphone 2 can be calculated. These computations can be done at the ADP module 206 as the mobile device coordinate initialization is performed.

Successive movements of the mobile device can be recorded by the position sensors (e.g., via the accelerometer sensor 902a) and gyro sensor 902c and combined with the original position of the mobile device. These successive movements can be calculated with respect the mobile device center. The movement of the microphone 1 (mic 1) or (mic 2) positions (FIG. 1) with respect to the ERC origin can be calculated using the mobile device center movements combined with the known placement of mic 1 or mic 2 with respect to the mobile device center.

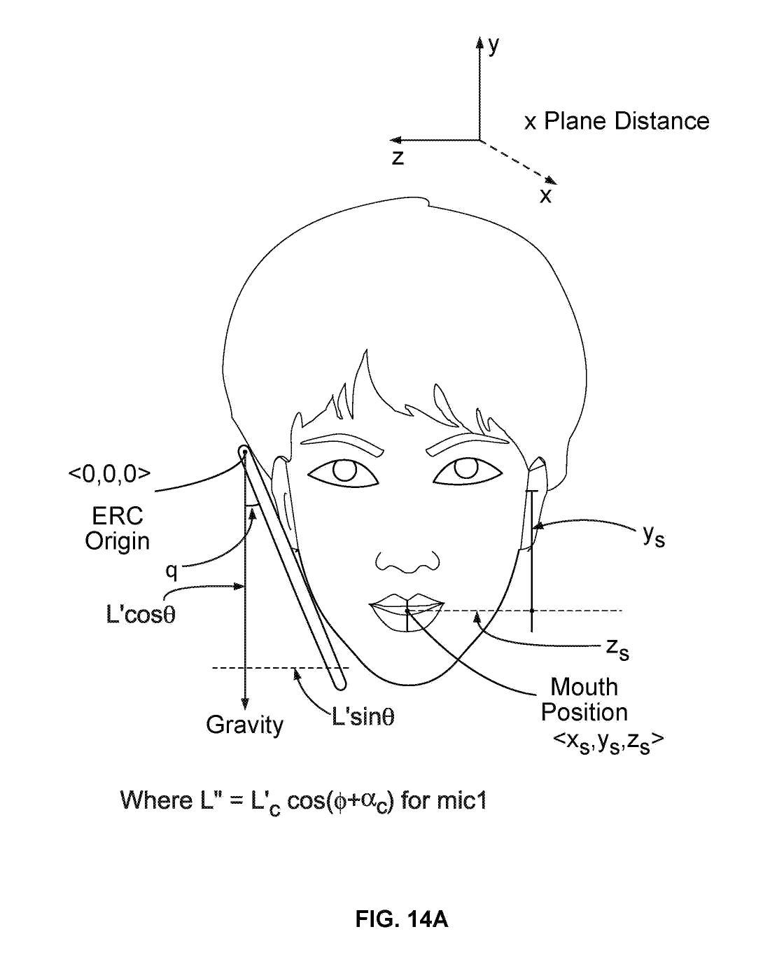

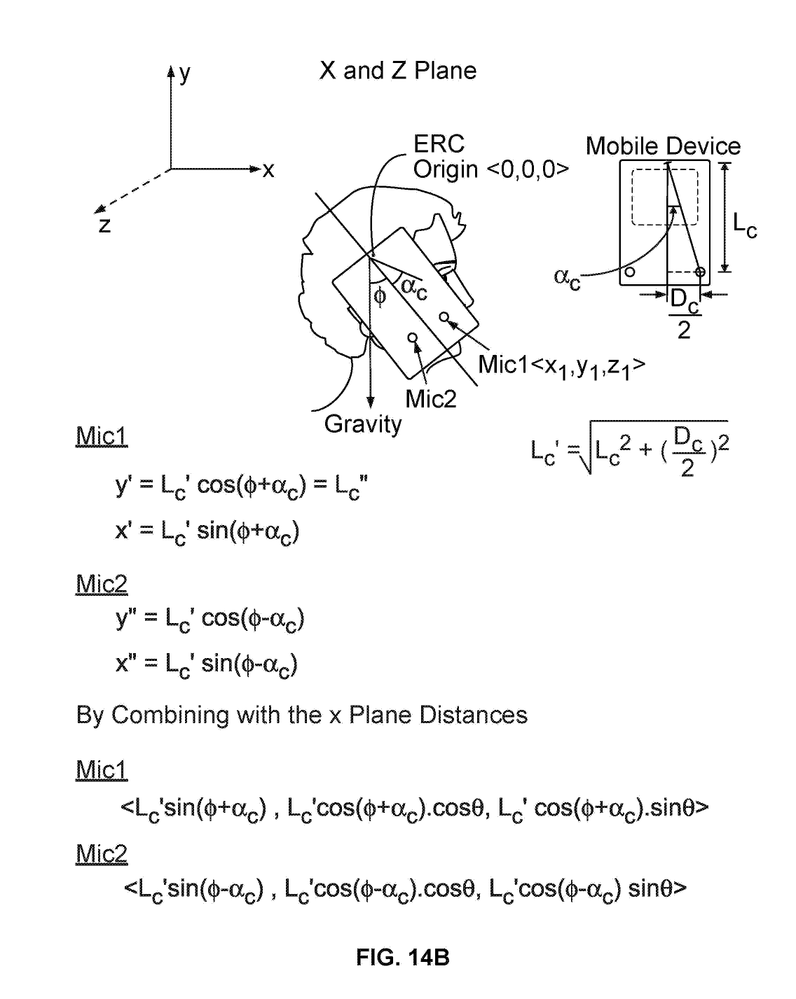

FIGS. 14A and 14B illustrate an exemplary method of calculating the position of mic 1 and mic 2 in ERC. An example of an initial position calculation of mic 1 is illustrated in FIG. 14A with only x-axis rotations

M1p=<0, L_{c} cos θ, 0, L_{c} sin θ>, (11)

where L_{c} is the length of the mobile device, α_{c} is the angle the microphone makes with the center line of the mobile device as shown in FIG. 14B. Angle θ is the angle the frontal plane of the mobile device makes with the gravity vector at initialization and φ is the angle the center line of the mobile device makes with the projection of the gravity vector on the device plane, as shown in FIG. 14B.

The angle θ represents the tilting level of the mobile device and the angle φ represents the rotating level of the mobile device with regard to the gravity vector. These two angles determine the relative position of the two microphones in ERC. The following is an example calculation given known values for the angles θ and φ.

With x-axis and z-axis rotation components at the initialization according to FIG. 14A and FIG. 14B, M1p is extended to

$$\begin{matrix}M1p = 〈 \sqrt{( {L}_{c}^{2} + \frac{{D}_{c}^{2}}{2} )} sin ( φ + {α}_{c} ) , \sqrt{( {L}_{c}^{2} + \frac{{D}_{c}^{2}}{2} )} cos θ cos ( φ + {α}_{c} ) , \sqrt{( {L}_{c}^{2} + \frac{{D}_{c}^{2}}{2} )} cos ( φ + {α}_{c} ) sin θ 〉 & ( 12 ) \\ M 2 p = 〈 \sqrt{( {L}_{c}^{2} + {D}_{c}^{2} )} sin ( φ - {α}_{c} ) \sqrt{( {L}_{c}^{2} + {D}_{c}^{2} )} cos θcos ( φ - {α}_{c} ) \sqrt{( {L}_{c}^{2} + \frac{{D}_{c}^{2}}{2} )} cos ( φ - {α}_{c} ) sin θ 〉 & ( 13 )\end{matrix}$$

In some implementations, motion context processing can provide information as to the cause of prior motion of the mobile device based on its trajectory, such as whether the motion is caused by the user walking, running, driving etc. This motion information can be subtracted from the movements after the mobile device is used to compensate for ongoing movements.

The ADP module 206 output can also be used to determine the incident angles of speech for one or more onboard microphones defined as θ(k) =[θ₁(k), θ₂(k) . . . θᵢ₊ₙ(k)], where the subscript i denotes a specific microphone in a set of microphones and n denotes the total number of microphones in the set. In the example shown, a primary and secondary microphone (mic1, mic2) are located at the bottom edge of the mobile device and spaced a fixed distance apart.

Referring to FIG. 1 it can be assumed that in handset mode loudspeaker 106 of mobile device 102 is close to the ear of user 104. Using the ADP module it is possible to determine an angle Φ with which mobile device 102 is held relative to the face of user 104, where Φ can be defined in an instantaneous coordinate frame, as shown in FIG. 1. Using Φ and the length of mobile device 102, L, the distances, X1, X2 from the mouth of user 104 to the mic1 and mic2, respectively, can be calculated.

To improve accuracy, a Kalman filter based inertial navigation correction can be used for post processing inside the ADP module to remove bias and integration errors at the ADP module.

Assuming that user 104 is holding mobile device 102 against her left ear with the microphones (the negative x axis of the device) pointing to the ground (handset mode), Φ can be defined as the angle that would align a Cartesian coordinate frame fixed to mobile device 102 with an instantaneous coordinate frame. In practice, any significant motion of mobile device 102 is likely confined in the x-y plane of the coordinate frame fixed to mobile device 102. In this case, a first axis of the instantaneous Cartesian coordinate frame can be defined using a gravitational acceleration vector [symbol] computed from accelerometer measurements. A speech microphone based vector or magnetometer can be used to define a second axis. A third axis can be determined from the cross product of the first and second axes. Now if user 104 rotates mobile device 102 counterclockwise about the positive z-axis of the instantaneous coordinate frame by an angle Φ, the microphones will be pointing behind user 104. Likewise, if user 104 rotates mobile device 102 clockwise by an angle Φ, the microphones will be pointing in front of the user.

Using these coordinate frames, angular information output from one or more gyros can be converted to Φ, which defines an orientation of the face of user 104 relative to mobile device 102. Other formulations are possible based on the gyro platform configuration and any coordinate transformations used to define sensor axes.

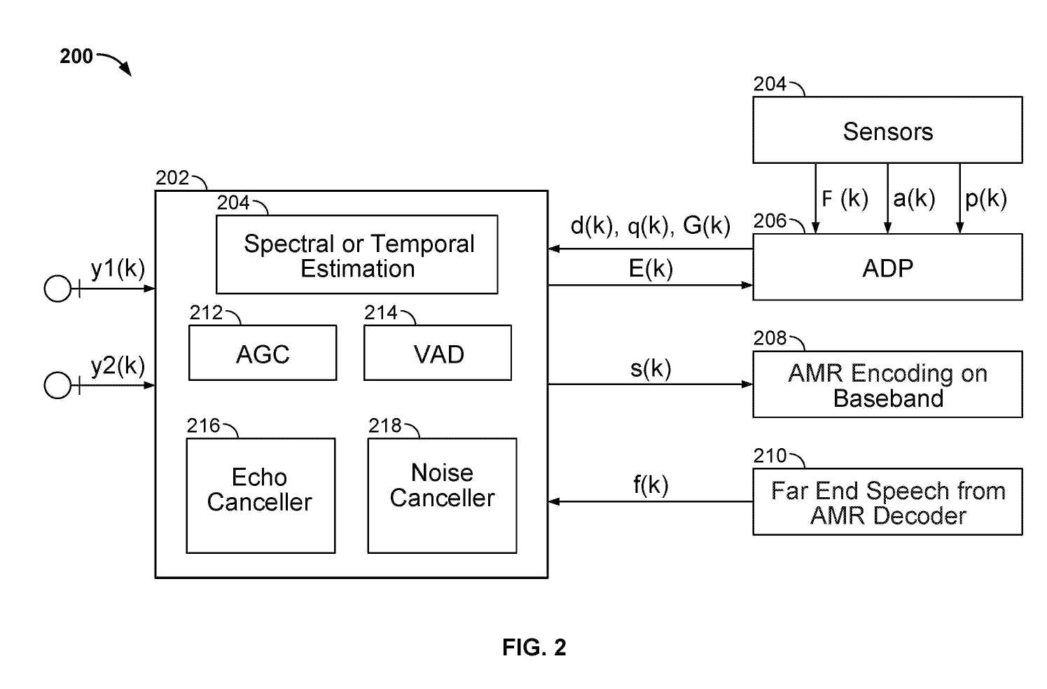

Once Φ is calculated for each table 908 entry, an incident angle of speech for each microphone θ(k)=[θ₁(k), θ₂(k) . . . θᵢ₊ₙ(k)] can be calculated as a function of Φ. The incident angle of speech, delays, d1(k), d2(k) and distances X1, X2 can be computed in ADP module 206, as described in reference to FIG. 2.

### Example Echo & Noise Cancellation System

FIG. 2 is a block diagram of an example echo and noise cancellation system 200 assisted by an ADP module 206. System 200 can include speech processing engine 202 coupled to ADP module 206, encoder 208 and decoder 210. Sensors 204 can include but are not limited to accelerometers, gyroscopes, proximity switches, or other sensors. Sensors 204 can output sensor data including gyroscope angular output data Φ(k), accelerometer output data a(k), and proximity switch output data p(k), as well as other system data. In some implementations, one or more sensors 204 can be MEMS devices. ADP module 206 can be coupled to sensors 204, and receives the sensor output data. The acceleration output data a(k) and angular output data Φ(k) can be vectors of accelerations and angles, respectively, depending on whether one, two or three axes are being sensed by accelerometers and gyros.

Encoder 208 can be, for example, an Adaptive Multi-Rate (AMR) codec for encoding outgoing baseband signal s(k) using variable bit rate audio compression. Decoder 210 can also be an AMR or EVRC family codec for decoding incoming (far end) encoded speech signals to provide baseband signal f(k) to speech processing engine 202.

Speech processing engine 202 can include one or more modules (e.g., a set of software instructions), including but not limited to: spectral/temporal estimation module 204, AGC module 212, VAD module 214, echo canceller 216 and noise canceller 218. In the example shown, microphones mic 1, mic 2 receive a speech signal from user 104 and output signals y1(k), y2(k) microphone channel signals (hereafter also referred to as “channel signals”) which can be processed by one or more modules of speech processing engine 202.

Spectral or temporal estimation module 204 can perform spectral or temporal estimation 204 on the channel signals to derive spectral, energy, phase, or frequency information, which can be used by the other modules in system 200. In some implementations, an analysis and synthesis filter bank is used to derive the energy, speech and noise components in each spectral band and the processing of signals can be combined with the ADP. AGC module 212 can use the estimated information generated by module 204 to adjust automatically gains on the channel signals, for example, by normalizing voice and noise components of the microphone channel signals.

Echo canceller 216 can use pre-computed echo path estimates to cancel echo signals in system 200. The echo canceller coefficients can be calculated using a HAT or KEMAR mannequin with the mobile device for use in table 908. By using these preset coefficients, the echo canceller adaptation can be less aggressive for echo path changes. Switching between the echo paths can be done with interpolation techniques to avoid sudden audio clicks or audio disturbances with large path changes.

Echo canceller 216 can include an adaptive filter having filter coefficients selected from a look-up table based on the estimated angles provided by ADP module 206. The echo cancellation convergence rate can be optimized by pre-initializing the adaptive filter with known filter coefficients in the table. Echo canceller 216 can use a Least Mean Squares (LMS) or Normalized LMS (NLMS) based adaptive filter to estimate echo path for performing the echo cancellation. The adaptive filter can be run less often or in a decimated manner, for example, when mobile device 102 is not moving in relation to the head of user 104. For example, if the accelerometer and gyro data are substantially zero mobile device 102 is not moving, and the adaptive filter calculations can be performed less often to conserve power (e.g., less MIPS).

VAD module 214 can be used to improve background noise estimation and estimation of a desired speech signals. ADP module 206 can improve performance of VAD module 214 by providing one or more criteria in a Voice/Non-Voice decision.

In some implementations, table 908 can include a number of adaptive filter coefficients for a number of angle values, proximity switch values, and gain values. In some implementations, the filter coefficients can be calculated based on reflective properties of human skin. In some implementations, filter coefficients can be calculated by generating an impulse response for different mobile device positions and calculate the echo path based on the return signal. In either case, the filter coefficients can be built into table 908 during offline calculation. Vector quantization or other known compression techniques can be used to compress the table 908.

FIG. 10 illustrates an example table 908 with 64 entries that can be compressed to accommodate memory constraints. During runtime speech processing engine 202 can format the outputs of the proximity sensors, speaker gains, and ADP angles into a vector. A vector distance calculation (e.g., Euclidean distance) can be performed between the runtime vector and vectors in the table 908. The table vector having the smallest distance can determine which adaptive filter coefficients to be used to pre-initialize the adaptive filter, thus reducing adaptive filter convergence time. Additionally, selecting an adaptive filter coefficient from table 908 can ensure that adaptation can be executed less often depending on positional shifts of mobile device 102. In this example, when mobile 102 device is stationary, the adaptation is by default executed less often.

ADP module 206 tracks user 104 and mobile device 102 relative orientations and performs calculations using the tracked data. For example, ADP module 206 can use sensor output data to generate accurate microphone delay data d(k), gain vector data G(k), and the incident angles of speech θ(k). ADP module 206 can pass raw sensor data or processed data to speech processing engine 202. In some implementations, speech processing engine 202 can track estimated delays and gains to provide error correction vector data E(k) back to ADP module 206 to improve the performance of ADP module 206. For example, E(k) can include delay errors generated by AGC 212 by calculating estimated values of delay and comparing those values with the calculated delays output from ADP module 206. ADP module 206 can compensate for lack of information with respect to the position of mobile device 102 using the received delay errors.

### Example ADP Assisted Gain Calculation System

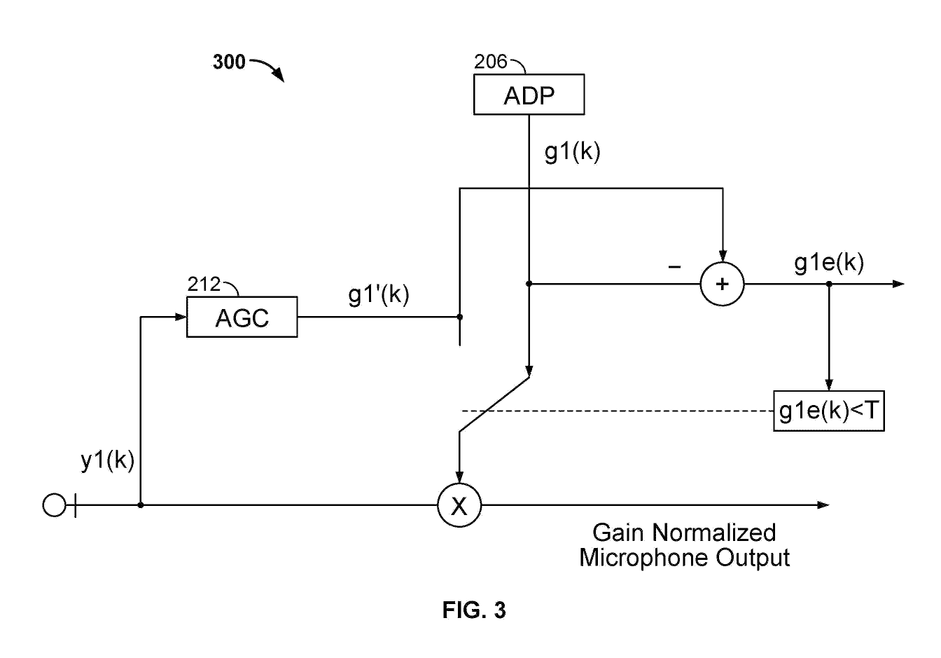

FIG. 3 is a conceptual block diagram of an example gain calculation system 300 for a single microphone (e.g., primary microphone y1(k)). System 300, however, can work with multiple microphones. In some implementations, the AGC gain for the desired distance from the microphone to the mouth is calculated by AGC module 212. An example of this distance calculation is described in Eq. 12 and Eq. 13 as M1p and M2p for a two-microphone system. The geometry for these distance calculations is illustrated in FIGS. 14A and 14B. The desired audio signal attenuates with distance or proportional to 1/M1p. ADP module 206 continually monitors the M1p and calculates this gain. In some implementations, these gains are pre calculated and stored in table 908.

In some implementations, system 300 can use a gain error between an estimated gain calculated by AGC module 212 and a gain calculated by ADP module 206. If the gain error g1e(k) is larger than a threshold value T, then gain g1′(k) calculated by AGC module 212 is used to normalize the microphone channel signal y1(k). Otherwise, the gain g1(k) calculated by ADP module 206 is used to normalize the output signal y1(k). AGC module 212 can use parameters such as the distance of mobile device 102 from a Mouth Reference Position (MRP) to adjust signal gains. For example, AGC module 212 can increase gain on the microphone channel signal y1(k) as mobile device 102 moves away from the MRP. If the gain error g1e(k) exceeds the threshold T, then ADP module 206 cannot accurately track the incident angle of speech and the estimated AGC gain g1′(k) maybe more reliable then the ADP gain g1(k) for normalizing the channel signal y1(k).

### Example ADP Assisted Primary Microphone Selection

In some implementation where one, two, or more microphones act as primary microphones and reference (secondary) microphones. The primary microphones are selected based on the ADP output. The bottom front face microphones are used as primary microphone when the mobile device is near the ear. The ADP is supplemented with the proximity sensor for confirmation of this position. The microphones on the back and top are used as noise reference microphones. When the ADP identifies that the mobile device has moved into the speakerphone position, or in front of the user, primary microphone selection can be changed to the upper front-face microphones. The microphones that are facing away from the user can be selected as noise reference microphones. This transition can be performed gradually without disrupting the noise cancellation algorithm.

When the mobile device is placed between the speakerphone and handset position, in one implementation both microphones can be made to act as primary microphones and single channel noise cancellation can be used instead of dual channel noise cancellation. In some implementations, the underlying noise canceller process can be notified of these changes and deployment of microphone combining can be done based on the ADP module.

### Example ADP Assisted Microphone Dependent Beamformer Configuration

In some implementations, when the mobile device is placed on a stable orientation for an example on a table, seat, dashboard of a car and speakerphone mode is selected, some of the microphones may be covered due the placement of the mobile device. If, for example, the front facing microphones are face down on a car seat the microphones will be covered and cannot provide speech information due to blockage. In this case, the useable microphone or groups of microphones can be selected based on the ADP information for capturing the speech audio signal. In some cases, beamforming can be done with the rear microphones only, the front microphones only or the microphones on the side of the mobile device. ADP output can be used for this selection of microphones based on the placement to avoid complex signal processing for detecting the blocked microphone.

In an implementation where the mobile device includes two or more microphones, the microphones can be combined in groups to identify background noise and speech. Bottom microphones can be used as primary microphones and the microphone on the back can be used as a noise reference microphone for noise reduction using spectral subtraction. In some implementations, the microphone selection and grouping of the microphones can be done based on information from the ADP module. In one implementation, when the mobile device is close to the ERC origin (at the ear). The two or three microphones at the bottom of the mobile device can be used for beamforming, and the microphones at the top and back of the mobile device can be used as noise reference microphones.

When the mobile device is moved away from the ERC origin, the microphone usage can change progressively to compensate for more noise pick up from the bottom microphones and more speech from the other microphones. A combined beamformer with two, three or more microphones can be formed and focused at the user's mouth direction. The activation of the microphone-combining process can be based on movement of the mobile device relative to ERC origin computed by the ADP module. To improve the speech quality ADP based activation a combination of noise cancellation, dereverberation and beamforming techniques can be applied. For example, if the unit has been positioned for speakerphone position (directly in front of the user, where user can type on the key board) the microphone configuration can be moved into de reverberating of speech with far field setting.

### Example ADP Assisted Large Movement or Activity Based Speech Improvement

The ADP module can be used to identify the usage scenario of the mobile device by long-term statistics. The ADP module can identify the activity the mobile device user engages in based on ongoing gyro and accelerometer sensor statistics generated at the ADP module. The statistical parameters can be stored on the ADP module for most potential use scenarios for the mobile device. These parameters and classifications can be done prior to the usage. Examples of ADP statistics that are stored include but are not limited to movements of the mobile device, its standard deviation and any patterns of movements (e.g., walking, running, driving). Some examples of use scenarios that the ADP module identifies is when the mobile device is inside a moving car or the mobile user is engaged in running, biking or any other activity.

When the ADP module identifies that the user is engaged in one of the preset activity, an activity specific additional signal processing modules is turned on. Some examples of these additional module are, more aggressive background noise suppression, wind noise cancellation, VAD level changes that are appropriate, and speaker volume increases to support the movement.

The spectral subtraction or minimum statistics based noise suppression can be selected based on ADP module scenario identification. In some implementations, when the ADP module detects a particular activity that the mobile device is engaged in, stationary background noise removal or rapid changing background noise removal can be activated. Low frequency noise suppression, which is typically deployed in automobile or vehicular transportation noise cancellation, can be activated by the ADP module after confirming that the mobile device is moving inside a vehicle.

When the ADP module detects biking, jogging or running signal processing can be used to remove sudden glitches, click and pop noises that dominate when the clothing and accessories rub or make contacts with the mobile device.

### Example of Beamforming System Using ADP Module

In some implementations, beamforming can be used to improve the speech capturing process of the mobile device. The beamformer can be directed to the user's mouth based on position information and ATF's (Acoustic Transfer Functions). In some implementations, the ADP module can track the position of the mobile device with the aid of table 908 (FIG. 10) of potential positions. When the mobile device is at a specific position corresponding ATF's from each microphone to mouth can be provided to the beamformer module.

For the two microphone beamformer implementation, the ATF's can be estimated a priori to be g₁=[g_{1,0}, . . . , g_{1,L}_{_{g}}₋₁] and g₂=[g_{2,0}, . . . , g_{2,L}_{_{g}}₋₁] using a HAT or KEMAR mannequin in a control setting. The value of L_{g} is the length of ATF. The ATF's can be estimated for each handset position. The following signal model can be used to show details of the TF-GSC system used in the mobile device. The source speech vector is expressed as

s₁(k)=[s₁(k), s₁(k−1), . . . s₁(k−Lₕ+1)], (14)

where the value of Lₕ is the length of beamforming filter for each microphone. The two microphone pickup signals can be written as:

y₁(k)=[y₁(k), y₁(k−1), . . . y₁(k−Lₕ+1)]^{T}

y₂(k)=[y₂(k), y₂(k−1), . . . y₂(k−Lₕ+1)]^{T}

y(k)=[y₁(k); y₂(k)]^{T} (15)

The additive noise vector is written as:

v₁(k)=[v₁(k), v₁(k−1), . . . v₁(k−Lₕ+1)]^{T},

v₂(k)=[v₂(k), v₂(k−1), . . . v₂(k−Lₕ+1)]^{T}

v(k)=[v₁(k), v₂(k)]^{T} (16)

The concatenated signal model is rewritten in form as

y(k)=G·s₁(k)+v(k), (17)

where G is the Toeplitz matrix generated by the two ATF's from the ADP module, given by

$$\begin{matrix}G = [ {G}_{1} ; {G}_{2} ] , \\ and & ( 18 ) \\ {G}_{1} = \begin{matrix}{g}_{1 , 0} & … & {g}_{1 , {L}_{g} - 1} & 0 & 0 & … & 0 \\ 0 & {g}_{1 , 0} & … & {g}_{1 , {L}_{g} - 1} & 0 & … & 0 \\ ⋮ & ⋮ & ⋮ & ⋮ & ⋮ & ⋮ & ⋮ \\ 0 & 0 & … & 0 & {g}_{1 , 1} & … & {g}_{1 , {L}_{g} - 1}\end{matrix} & ( 19 )\end{matrix}$$

With the above model linearly constrained minimum variance (LCMV) filter is formalized to identify the beamformer coefficients h:

$${min}_{h} {h}^{T} {R}_{y , y} h , subject to {G}^{T} h = u \qquad ( 20 )$$

where h is the beamformer filter, R_{y,y}=E[y^{T}(k)y(k)] is the correlation matrix of microphone pickup and u=[1, 0, . . . , 0] is a unit vector.

The optimum solution is given by:

h_{LCMV}=R_{y,y}⁻¹G(G^{T}R_{y,y}⁻¹G)⁻¹u (21)

The above LCMV filter can be implemented in Generalized Side-lobe Canceler (GSC) structure in the following way;

h_{LCMV}=f−BW_{GSC} (22)

where f=G(G^{T}R_{y,y}⁻¹G)⁻¹u is the fixed beamformer, blocking matrix B is the null space of G, and W_{GSC}=(B^{T}R_{y,y}⁻¹B)⁻¹B^{T}R_{y,y}f is the noise cancelation filter.

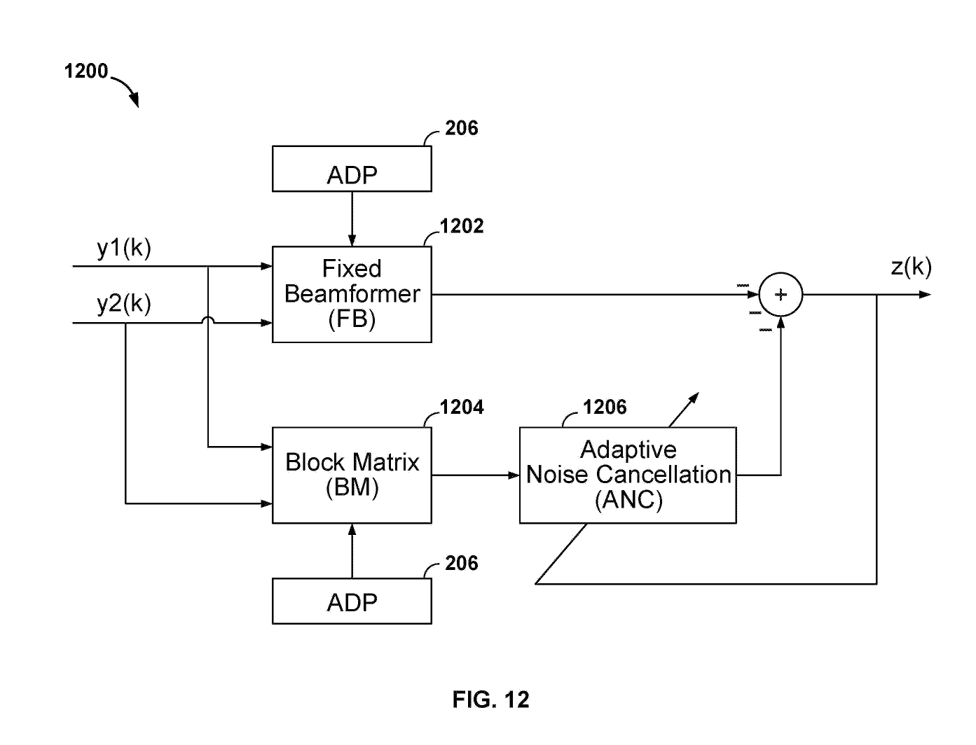

FIG. 12 is a block diagram of an example ADP based LCMV/TF-GSC beamformer. The GSC structure in FIG. 12 shows the typical structure of a transfer function generalized side lobe canceller comprising of three blocks. A fixed beamformer (FBF) 1202, which time aligns the speech signal components, a blocking matrix (BM) 1204, which blocks the desired speech components and only pass the reference noise signals, and a multichannel adaptive noise canceller (ANC) 1206, which eliminates noise components that leak through the side lobes of the fixed beamformer components. Theoretically, a perfect dereverberation is possible if the transfer matrix G is known or can be accurately estimated. Module BM 1204 and FBF 1202 components can be updated by ADP module 206 based on the mobile device position. When the mobile device moves into a new position ADP module 206 identifies this position and changes FBF 1202 and BM 1204 filters gradually to avoid sudden disruptions in the system.

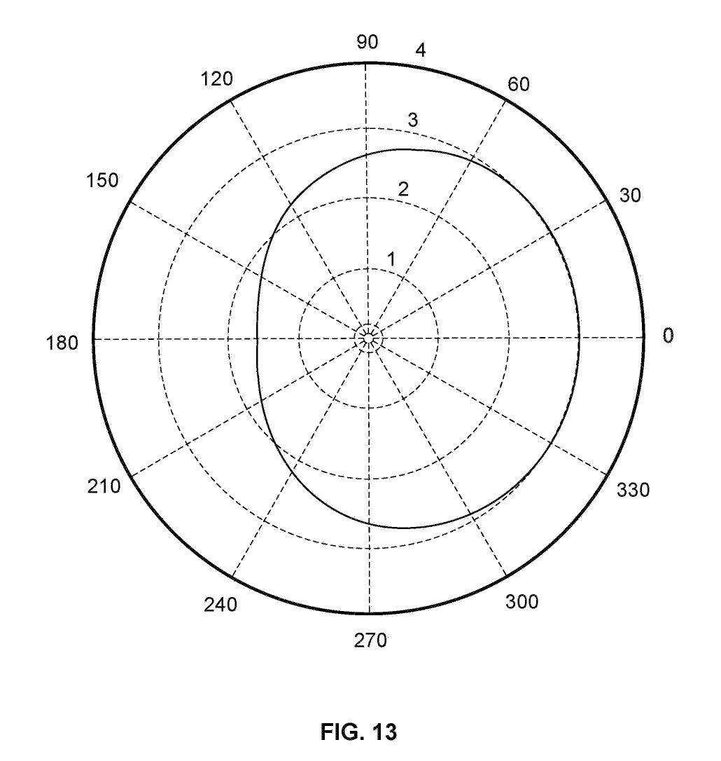

FIG. 13 illustrates an example beam pattern for a MVDR beamformer using two microphones. The maximum SNR improvement with two microphones is 3 dB for white noise. It could reach around 6 dB for diffuse noise. More SNR can be gained by using more microphones.

### Example of MVDR Beamforming System Incorporating the ADP Output

In some implementations, the attitude information obtained from the ADP module can be utilized to design a beamformer directly. For a system with two microphones, detailed position calculation calculations for the microphones can be given by Eq. 11 and Eq. 12. These Cartesian coordinate positions can be transformed to equivalent spherical coordinates for mathematical clarity. The microphone 1 position with respect to ERC can be given by

M1p=[r₁, θ₁, φ₁]. (23)

An example of this transformation is given by

$$\begin{matrix}M 1 P = [ {x}_{1} , {y}_{1} , {z}_{1} ] \\ = [ {r}_{1} sin {θ}_{1} cos {φ}_{1} , {r}_{1} sin {θ}_{1} sin {φ}_{1} , {r}_{1} cos {θ}_{1} ] ,\end{matrix} \qquad ( 24 )$$

where r₁ its a distance, and θ₁ and φ₁ are the two angles in 3D space.

The ADP positions in spherical coordinates for microphone 2 and mouth is given by

M2p=[r₂, θ₂, φ₂] (25)

Pₛ=[rₛ, θₛ, φₛ] (26)

The mobile device microphone inputs are frequency-dependent and angle-dependent due to the position and mobile device form factor, which can be described by Aₙ(ω, θ, φ).

The microphone pickup in frequency domain is expressed as Y₁(ω) and Y₂(ω) where

Y₁(ω)=α₁(ω, θ, φ)S(ω)+V₁(ω), (27)

Y₂(ω)=α₂(ω, θ, φ)S(ω)+V₂(ω). (28)

The attenuation and phase shift on each microphone are described as

α₁(ω, θₛ, φₛ)=A₁(ω, θₛ, φₛ)e^{-jωτ}^{₁}^{(θ}^{ₛ}^{, φ}^{ₛ}⁾, (29)

α₂(ω, θₛ, φₛ)=A₂(ω, θₛ, φₛ)e^{-jωτ}^{₂}^{(θ}^{ₛ}^{, φ}^{ₛ}⁾. (30)

The distance between mouth and microphone 1 is given by

$$\begin{matrix}M 1 P - {P}_{s} = \sqrt{{( {x}_{1} - {x}_{s} )}^{2} + {( {y}_{1} - {y}_{s} )}^{2} + {( {z}_{1} - {z}_{s} )}^{2}} \\ = \sqrt{\begin{matrix}{( {r}_{1} sin {θ}_{1} cos {φ}_{1} - {r}_{s} sin {θ}_{s} cos {φ}_{s} )}^{2} + \\ {( {r}_{1} sin {θ}_{1} sin {φ}_{1} - {r}_{1} sin {θ}_{1} sin {φ}_{1} )}^{2} + {( {r}_{1} cos {θ}_{1} - {r}_{1} cos {θ}_{1} )}^{2}\end{matrix}} \\ = \sqrt{{r}_{s}^{2} + {r}_{1}^{2} + 2 {r}_{1} {r}_{s} cos {θ}_{s} cos {θ}_{1} cos ( {φ}_{s} - {φ}_{1} ) - 2 {r}_{s} {r}_{1} sin {φ}_{s} sin {φ}_{1}}\end{matrix} \qquad ( 31 )$$

The in polar coordinates delays τ₁(θₛ, φₛ) and τ₂(θₛ, φₛ) can be calculated as

$$\begin{matrix}\begin{matrix}{τ}_{1} ( {θ}_{s} , {φ}_{s} ) = \frac{M 1 p - {P}_{s}}{c} {f}_{s} \\ = \sqrt{( \begin{matrix}{r}_{s}^{2} + {r}_{1}^{2} + 2 {r}_{1} {r}_{s} cos {θ}_{s} cos {θ}_{1} cos ( {φ}_{s} - {φ}_{1} ) - \\ 2 {r}_{s} {r}_{1} sin {φ}_{s} sin {φ}_{1}\end{matrix} )} \frac{{f}_{s}}{c}\end{matrix} & ( 32 ) \\ \begin{matrix}{τ}_{2} ( {θ}_{s} , {φ}_{s} ) = \frac{M 2 p - {P}_{s}}{c} {f}_{s} \\ = \sqrt{( \begin{matrix}{r}_{s}^{2} + {r}_{2}^{2} + 2 {r}_{2} {r}_{s} cos {θ}_{s} cos {θ}_{2} cos ( {φ}_{s} - {φ}_{2} ) - \\ 2 {r}_{s} {r}_{1} sin {φ}_{s} sin {φ}_{2}\end{matrix} )} \frac{{f}_{s}}{c}\end{matrix} & ( 33 )\end{matrix}$$

Where fₛ is sampling frequency and c is the speed of sound. The stacked vector of microphone signals of eq. 26 and eq. 27 can be written as

Y(ω)=[Y₁(ω), Y₂(ω)]^{T} (34)

The steering vector towards the users mouth is formed as

aₛ(ω)=[α₁(ω, θₛ, φₛ), α₂(ω, θₛ, φₛ)]^{T} (35)

The signal model is in frequency domain is rewritten in terms of vector.

Y(ω)=aₛ(ω)S(ω)+V(ω) (36)

For mathematical simplicity, equations are derived for a specific configuration. Where microphone 1 is the origin and microphone mounted on the x-axis. Then the steering vector is simplified for far-field signal, i.e.

aₛ(ω)=[1, e^{-jwr}^{₂} ^{cos(θ}^{ₛ}^{)f}^{ₛ}^{/c}]^{T} (37)

The output signal at specific frequency bin is

$$\begin{matrix}Z ( ω ) = {H}^{H} Y ( ω ) \\ = {H}^{H} {a}_{s} ( ω ) S ( ω ) + {H}^{H} V ( ω )\end{matrix} \qquad ( 38 )$$

Minimizing the normalized noise energy in the output signal, subject to a unity response in direction of the speech source leads to the cost function as

$${min}_{H} {H}^{H} {R}_{V , V} ( ω ) H , \\ subject to \\ {H}^{H} {a}_{s} = 1 \qquad ( 39 )$$

where R_{V,V}(ω)=E[V(ω)^{H}V(ω)] is the noise correlation matrix.

The solution to the optimization problem is

$${H}_{O , 1} ( ω ) = \frac{{[ {R}_{V , V} ( ω ) ]}^{- 1} {a}_{s} ( ω )}{{{a}_{s}^{H} ( ω ) [ {R}_{V , V} ( ω ) ]}^{- 1} {a}_{s} ( ω )} \qquad ( 40 )$$

In some implementations the above closed form equation is implemented as an adaptive filter which continusely update as the ADP input to it changes and signal conditions change.

### ADP Assisted Switching Between Speakerphone and Handset Modes

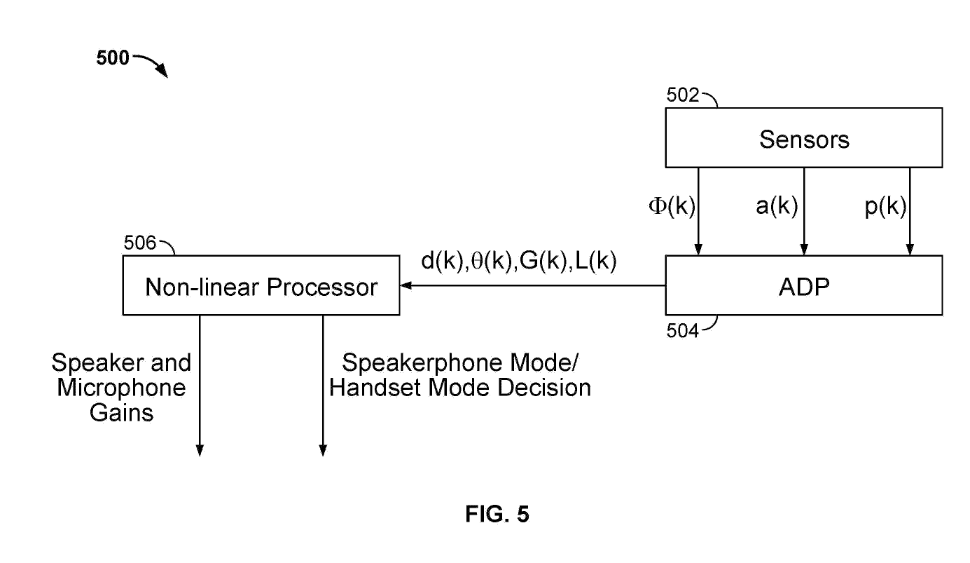

FIG. 5 is a block diagram of an example system 500 for automatic switching between a speakerphone mode and a handset mode in mobile device 102. The automatic switching between speakerphone mode and handset mode can be performed when mobile device 102 automatically detects that it is no longer in handset mode based on the output of one or more proximity switches, gyroscope sensors or speech amplitude signals.

System 500 includes ADP module 504, which receives data from sensors 502 on mobile device 102. The data can, for example, include gyroscope angular output Φ(k), accelerometer output a(k), and proximity switch output p(k). Using the sensor output data from sensors 502, ADP module 504 generates delay d(k), incident angle of speech θ(k), gain vector G(k), and estimated distance of mobile device 102 to a user's head L(k). The output parameters of ADP module 504 for proximity switches and angle can be used in nonlinear processor 506 to determine whether to switch from handset mode to speakerphone mode and vice versa.

In this example, ADP module 504 can track the relative position between user 104 and mobile device 102. Upon determining that a proximity switch output indicates that mobile device 102 is no longer against the head of user 104, the speakerphone mode can be activated. Other features associated with the speakerphone mode and handset mode can be activated as mobile device 102 transitions from one mode to the other. Further, as mobile device 102 transitions from a handset position to speakerphone position, ADP module 504 can track the distance of mobile device 102 and its relative orientation to user 104 using onboard gyroscopes and accelerometer outputs. System 500 can then adjust microphone gains based on the distance. In the event that user 104 moves mobile device 102 back to the handset position (near her head), system 500 can slowly adjust the gains back to the values used in the handset mode. In some implementations, activation of a separate loudspeaker or volume level is adjusted based on the origination and position of the mobile device provided by ADP module 504.

### ADP Assisted Voice Activity Detector

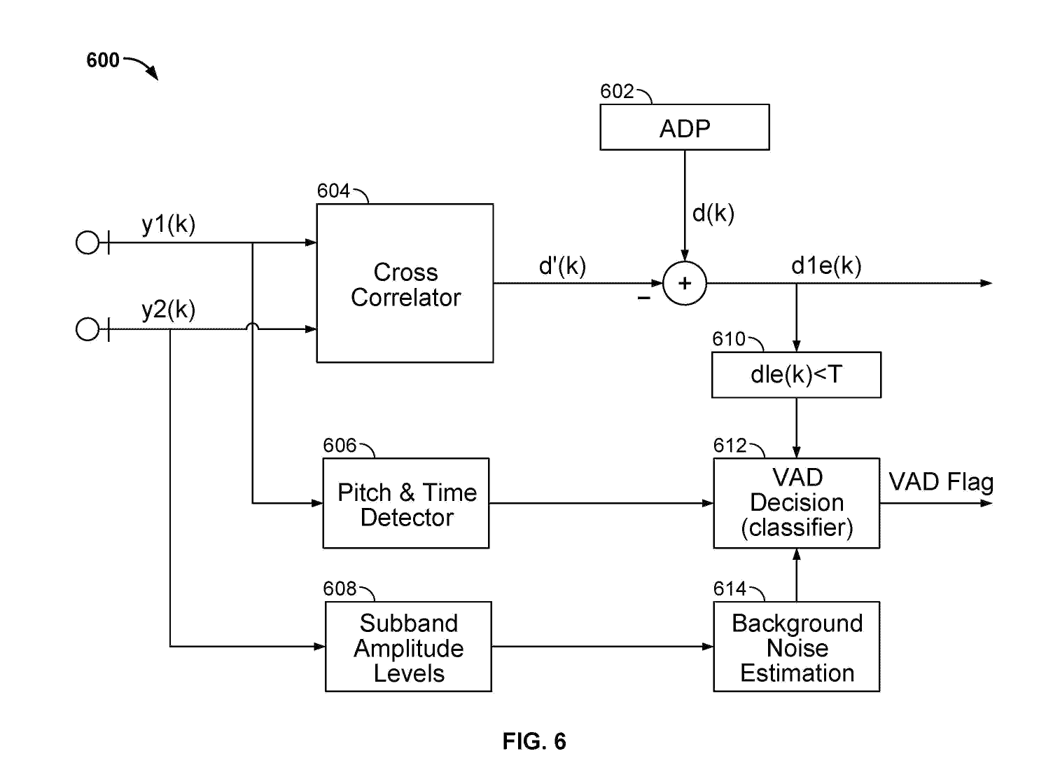

FIG. 6 is a block diagram of an example Voice Activity Detector (VAD) system 600 for detecting voice activity assisted by an ADP module 206. VAD module 214 can be used to improve background noise estimation and estimation of a desired speech signals. In some implementations, VAD system 600 can include ADP module 602, cross correlator 604, pitch and time detector 606, subband amplitude level detector 608, VAD decision module 612 and background noise estimator 614. Other configurations are possible.

Microphone channel signals y1(k), y2(k) are input into cross correlator 604 which produces an estimate delay d′(k). The estimated delay d′(k) is subtracted from the delay d(k) provided by ADP module 602 to provide delay error d1e(k). The primary channel signal y1(k) is also input into pitch and tone detector 606 and secondary channel signal y2(k) is also input into subband amplitude level detector 608. Amplitudes estimation is done using a Hilbert transform for each subband and combining the transformed subbands to get a full band energy estimate. This method avoids phase related clipping and other artifacts. Since the processing is done in subbands, background noise is suppressed before the VAD analysis. Pitch detection can be done using standard autocorrelation based pitch detection. By combining this method with the VAD, better estimates of voice and non-voice segments can be calculated.

The delay between the two microphones (delay error) is compared against a threshold value T and the result of the comparison is input into VAD decision module 612 where it can be used as an additional Voice/Non-Voice decision criteria. By using the ADP output positions of mic 1 and mic 2 with respect to the user, the time difference in speech signal arriving at microphone 1 and microphone 2 can be identified. This delay is given by Δτ₁₂=τ₁(θ_{S}, φ_{S})−τ₂(θ_{S}, φ_{S}), where τ₁(θₛ, φₛ) and τ₂(θₛ, φₛ) are delays in spherical coordinates detailed by Eq. 32 and Eq. 33:

$$\begin{matrix}Δτ ( {θ}_{s} , {φ}_{s} ) = {τ}_{2} ( {θ}_{s} , {φ}_{s} ) - {τ}_{1} ( {θ}_{s} , {φ}_{s} ) \\ = ( \begin{matrix}\sqrt{( \begin{matrix}{r}_{s}^{2} + {r}_{2}^{2} + 2 {r}_{2} {r}_{s} cos {θ}_{s} cos {θ}_{2} cos ( {φ}_{s} - {φ}_{2} ) - \\ 2 {r}_{s} {r}_{2} sin {φ}_{s} sin {φ}_{2}\end{matrix} ) -} \\ \sqrt{( \begin{matrix}{r}_{s}^{2} + {r}_{1}^{2} + 2 {r}_{1} {r}_{s} cos {θ}_{s} cos {θ}_{1} cos ( {φ}_{s} - {φ}_{1} ) - \\ 2 {r}_{s} {r}_{1} sin {φ}_{s} sin {φ}_{1}\end{matrix} )}\end{matrix} ) \frac{{f}_{s}}{c}\end{matrix} \qquad ( 41 )$$

For a given Δτ₁₂ signals originating from the user mouth can be identified for reliable VAD decision. In some implementations, this delay can be pre-calculated and included in table 908 for a given position.

This delay can also confirm the cross correlation peak as the desired signal and avoid VAD to trigger on external distracting when the cross-correlation method is used. The cross correlation based signal separation can be used for reliable VAD, the cross correlation for a two microphone system with microphone signals y₁(k) and y₂(k) (as shown in Eq. 15) can be given by

$$\begin{matrix}{R}_{{y}_{1} {y}_{2}} ( n ) = E [ {y}_{1} ( k ) {y}_{2} ( k + n ) ] \\ = \frac{1}{K} {\sum }_{k = 0}^{K - 1} {y}_{1} ( k ) {y}_{2} ( k + n ) \\ = \frac{1}{K} {\sum }_{k = 0}^{K - 1} [ {a}_{1} s ( k - {τ}_{1} ) + {v}_{1} ( k ) ] [ {a}_{2} s ( k - {τ}_{2} + n ) + {v}_{2} ( k + n ) ]\end{matrix} \qquad ( 42 )$$

Assume the noise is uncorrelated with the source speech, we have

$${R}_{{y}_{1} {y}_{2}} ( n ) = \frac{1}{K} {\sum }_{k = 0}^{K - 1} {a}_{2} {a}_{1} s ( k - {τ}_{1} ) s ( k - {τ}_{2} + n ) \frac{1}{K} {\sum }_{k = 0}^{K - 1} {v}_{1} ( k ) {v}_{2} ( k + n ) \qquad ( 43 )$$

The noise v₁(k) and v₂(k) are assumed to be independent with each other the noise power spectral density is given by

$$\begin{matrix}{R}_{{v}_{1} {v}_{2}} ( n ) = \frac{1}{K} {\sum }_{k = 0}^{K - 1} {v}_{1} ( k ) {v}_{2} ( k + n ) = {σ}_{v}^{2} & ( 44 ) \\ {R}_{{y}_{1} {y}_{2}} ( n ) = {R}_{s} ( ∇ τ ) + {R}_{vv} ( n ) & ( 45 )\end{matrix}$$

The component R_{S}(Δτ) can be identified since Δτ₁₂ is provided by the ADP module and the Rᵥᵥ(n)=σᵥ² is noise energy, which is slow changing. The voice activity detection is performed based on the relative peak of R_{y}_{₁}_{y}_{₂}(n). In some implementations this method is extended to multiple microphones and Δτ(θₛ, φₛ) can be extended to multi microphone VAD to make on Voice/Noise decision where a cross correlation is done between y₁(k) and y₂(k).

### ADP Based on Rotation Matrix and an Integrated MVDR Solution

In some implementations, using the principles above, a more robust and complete coordinate system and angular representation of the mobile device in relation to the user can be formed. In this method, the quaternion coordinates can be transformed to Rotation Matrix and the Rotation Matrix can be used to derive the attitude of the mobile device. The attitude can be used to determine the angle and distance based on certain assumptions.

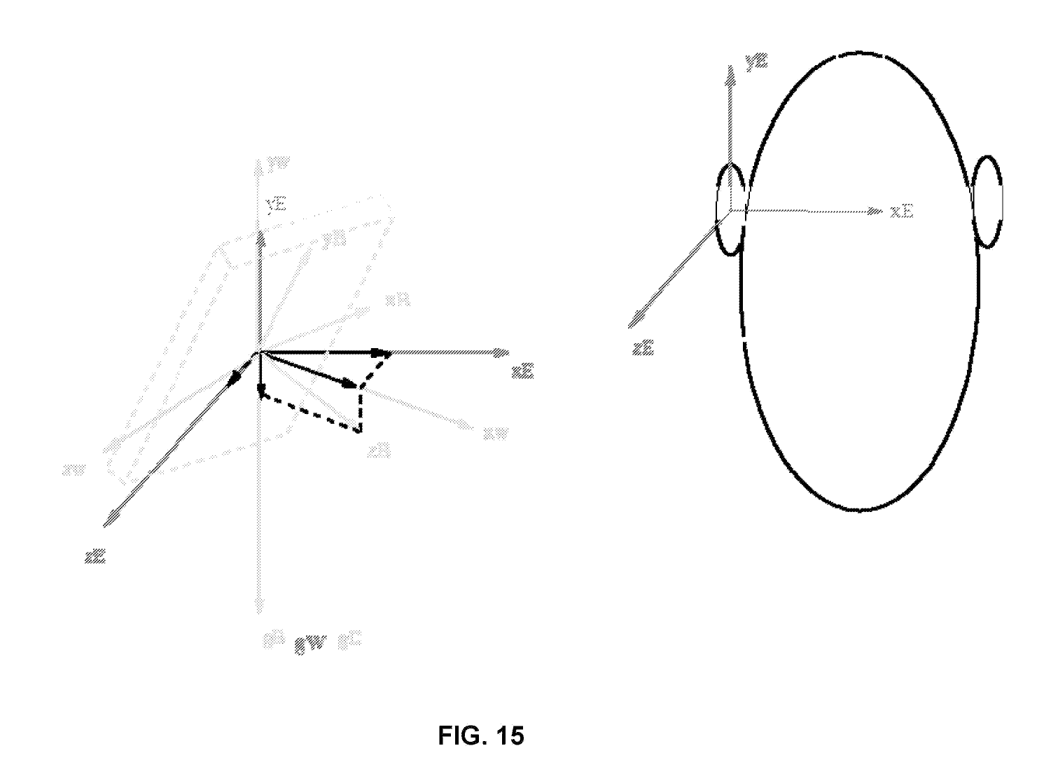

FIG. 15 illustrates three frame coordinates used in the ADP process based on a rotation matrix. The first coordinate frame is the device (or body) frame coordinate, denoted as, [\vec{x}_{B}, \vec{y}_{B}, \vec{z}_{B}]. In the device frame, \vec{z}_{B} represents the direction perpendicular to the plane of the phone, \vec{y}_{B} and \vec{x}_{B} are in parallel with the two edges of the device. The world frame coordinate is denoted as [\vec{x}_{W}, \vec{y}_{W}, \vec{z}_{W}]. In the world frame, \vec{y}_{W} represents the opposite direction to the gravity, while \vec{x}_{W} and \vec{z}_{W} complement the horizontal plane. Note that \vec{x}_{W} and \vec{z}_{W} are allowed to point to any direction in the horizontal plane. The ear frame coordinate is denoted as [\vec{x}_{E}, \vec{y}_{E}, \vec{z}_{E}], where the z-axis represents the forward direction of the mouth, the y-axis represents the up direction, and the x-axis completes the coordinate frame.

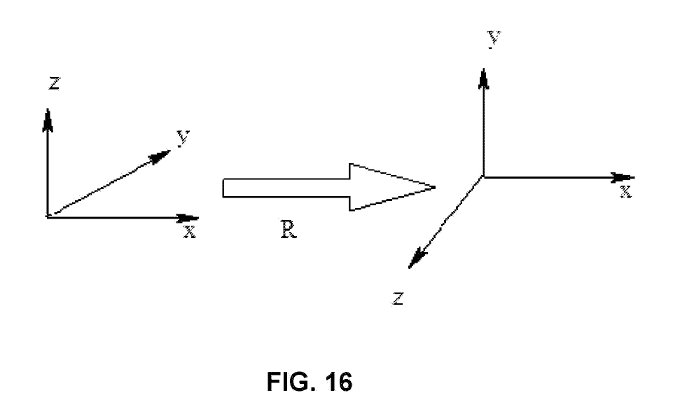

In order to calculate the distances and orientation, the transformation matrices between two different frames needs to be calculated first. The transformation matrix from device frame to world frame is denoted as ^{Wi}R_{B}, which can be obtained by Quaternion of the device attitude. The world coordinates system transferred from Quaternion possesses z-axis pointing up direction, while in ear system, the y-axis is pointing up, as shown in FIG. 16. We need to use another transmission matrix ^{W}R_{Wi} to rotate the world frame with z-axis up to the world frame with y-axis up is. From FIG. 16, we can easily obtain

$${}_{}^{W}{R}{}_{Wi}^{} = [ \begin{matrix}1 & 0 & 0 \\ 0 & 0 & 1 \\ 0 & - 1 & 0\end{matrix} ] . \qquad ( 46 )$$

Then the transformation matrix from device frame to the world frame with y-axis up is obtained as

^{W}R_{B}=^{W}R_{Wi}·^{Wi}R_{B} (47)

The transformation matrix from the world frame to ear frame coordinates is denoted as ^{E}R_{W}.

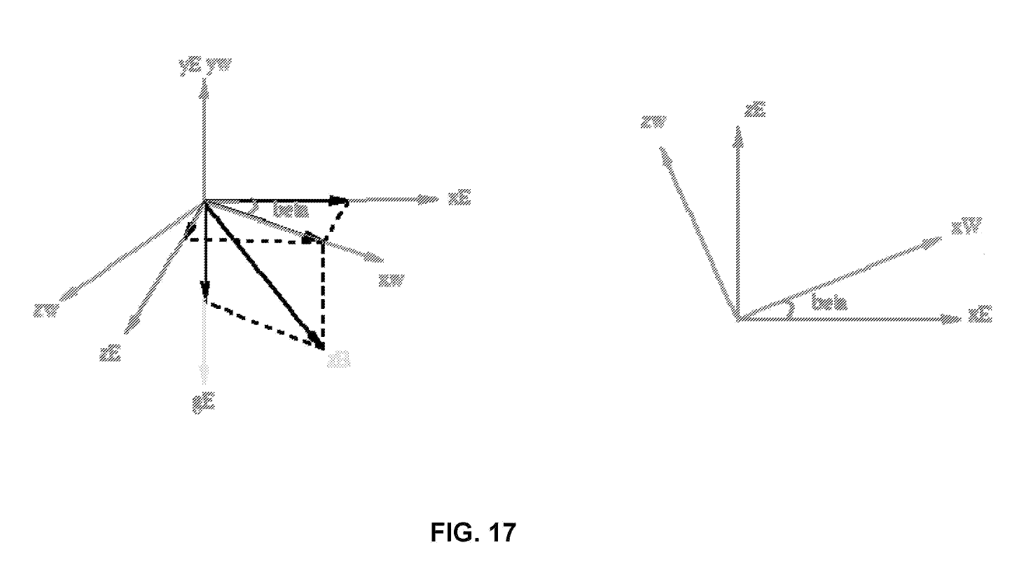

FIG. 17 illustrates a transformation from the world frame coordinate system to the EAR frame coordinate system. Since [symbol] _{W} is randomly chosen in the world frame system, the relationship between device frame and the ear frame must be known as a priori information. A reasonable assumption of [symbol] _{B}=− [symbol] _{E} when the mobile device is placed on the right ear, or \vec{x}_{B}=\vec{z}_{E} when it is on the left ear can be made. This assumption means the mobile device is held in parallel with the forward direction of the face. With this assumption, the transformation matrix ^{E}R_{W} can be calculated as

$${}_{}^{E}{R}{}_{W}^{} = [ \begin{matrix}cos β & sin β & 0 \\ - sin β & cos β & 0 \\ 0 & 0 & 1\end{matrix} ] , \qquad ( 48 )$$

where β is the acute angle [symbol] _{W} make with [symbol] _{E}.

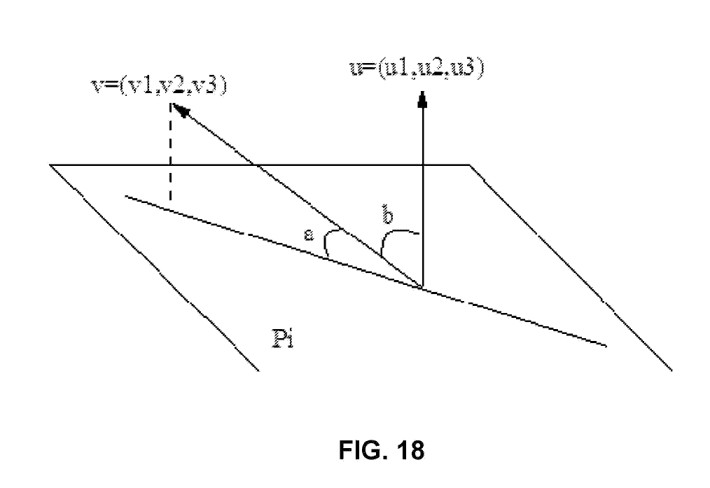

FIG. 18 shows the angle a between a line vector, [symbol] and a plane Pi (π), which is defined as the angle between line r and its orthogonal projection onto π. The angle between a line and a plane is equal to the complementary acute angle that forms between the direction vector of the line and the normal vector of the plane, [symbol] . The following equations express the calculation of the angle.

$$\begin{matrix}\vec{v} = ( {v}_{1} , {v}_{2} , {v}_{3} ) & ( 49 ) \\ \vec{u} = ( {u}_{1} , {u}_{2} , {u}_{3} ) & ( 50 ) \\ sin a = cos b = cos ( \vec{v} , \vec{u} ) = \frac{\vert \vec{v} \cdot \vec{u} \vert}{\vert \vec{v} \vert \vert \vec{u} \vert} & ( 51 ) \\ a = arcsin \frac{\vert \vec{v} \cdot \vec{u} \vert}{\vert \vec{v} \vert \vert \vec{u} \vert} = arcsin \frac{{v}_{1} {u}_{1} + {v}_{2} {u}_{2} + {v}_{3} {u}_{3}}{\sqrt{{v}_{1}^{2} + {v}_{2}^{2} + {v}_{3}^{2}} \sqrt{{u}_{1}^{2} + {u}_{2}^{2} + {u}_{3}^{2}}} & ( 52 )\end{matrix}$$

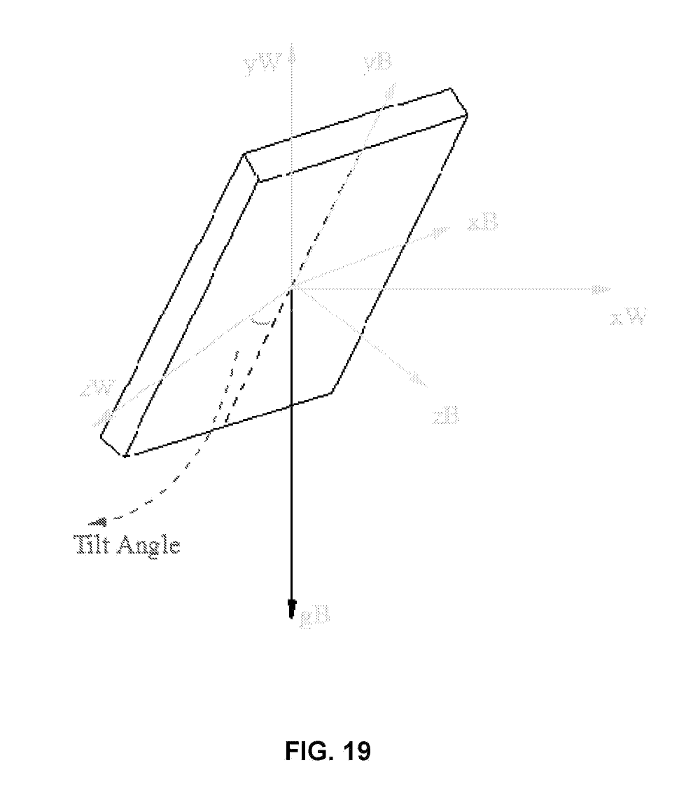

As shown in FIG. 19, the tilt angle is defined as the angle between the gravity vector [symbol] _{B} and the plane of display. As long as the transformation matrix ^{W}R_{B} can be calculated in Eq. 47, the gravity vector with respect to device frame [symbol] _{B} can be obtained by

[symbol]

_{B}=^{W}R_{B} [symbol] _{W}=^{B}R_{W}^{T} [symbol] _{W}, (53)

where [symbol] _{W}=[0, 0, −1].

The tilt angle α can be calculated as

$$α = arcsin \frac{{\vec{z}}_{B} \cdot {\vec{g}}_{B}}{\vert {\vec{z}}_{B} \vert \vert {\vec{g}}_{B} \vert} , \qquad ( 54 )$$

where [symbol] _{B} represents the orthogonal vector to the plane of the mobile device. The inner product in equation (54) results in the third component of [symbol] _{B}, since [symbol] _{B}=[0, 0, 1]. Since norm( [symbol] _{B})=1, Eq. 58 simplifies to

sin α= [symbol] _{B}(3), (55)

α=arcsin [symbol] _{B}(3). (56)

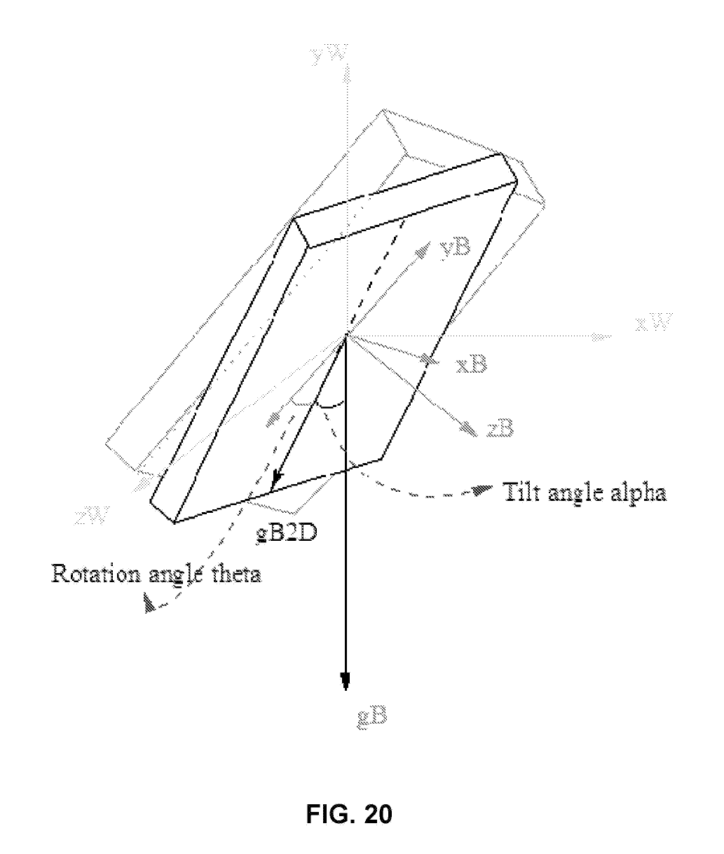

As shown in FIG. 20, the rotation angle θ is defined as the angle the y-axis of the device makes with the projection of gravity on the plane of the mobile device.

The projection of [symbol] _{B} on the plane of the mobile device is denoted as [symbol] _{B2D}. We have

$$\begin{matrix}{\vec{g}}_{B} = [ \begin{matrix}{\vec{g}}_{B} ( 1 ) \\ {\vec{g}}_{B} ( 2 ) \\ {\vec{g}}_{B} ( 3 )\end{matrix} ] , & ( 57 ) \\ {\vec{g}}_{B 2 D} = [ \begin{matrix}{\vec{g}}_{B} ( 1 ) \\ \vec{g} ( 2 ) \\ 0\end{matrix} ] . & ( 58 )\end{matrix}$$

Similar to the tilt angle, the rotation angle is calculated by the inner product as

$$cos θ = \frac{{\vec{y}}_{B} \cdot {\vec{g}}_{B 2 D}}{\vert {\vec{y}}_{B} \vert \vert {\vec{g}}_{B 2 D} \vert} \qquad ( 59 )$$

Since [symbol] _{B}=[0, 1, 0], the inner product results in the second component of [symbol] _{B2D}, which is same as the second component of [symbol] _{B}. Then we have

$$\begin{matrix}cos θ = \frac{{\vec{g}}_{B} ( 2 )}{\sqrt{{\vec{g}}_{B}^{2} ( 1 ) + {\vec{g}}_{B}^{2} ( 2 )}} , & ( 60 ) \\ θ = argcos \frac{{\vec{g}}_{B} ( 2 )}{\sqrt{{\vec{g}}_{B}^{2} ( 1 ) + {\vec{g}}_{B}^{2} ( 2 )}} & ( 61 )\end{matrix}$$

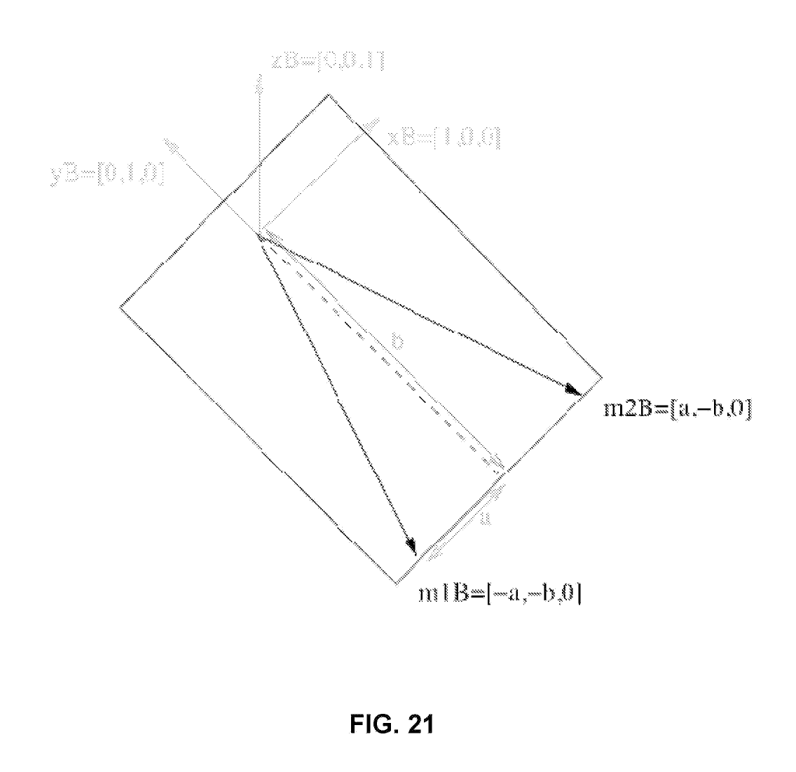

FIG. 21 illustrates the position of the i-th microphone with respect to the mobile device frame, which is denoted [symbol] _{iB}. Generally, the microphone geometry is fixed on the mobile device, thus [symbol] _{iB} is considered an a priori parameter.

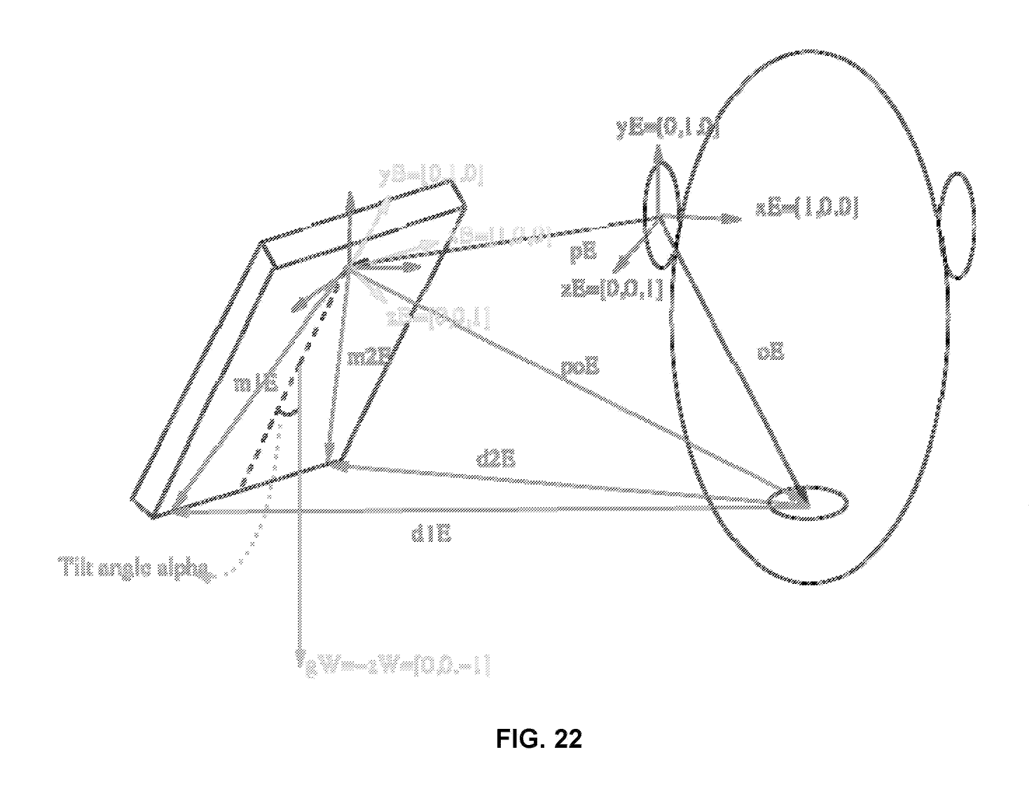

FIG. 22 illustrates how to calculate the distance from the mouth to microphone. In EFC, the position of the mobile device is noted as [symbol] _{E}, the position of ear is noted as [symbol] _{E}, the position of mouth is noted as [symbol] _{E} and the positions of i-th microphone on the device are denoted as [symbol] _{iE}. The line vector from mouth to microphone is noted as [symbol] _{iE} and the line vector from the phone to the mouth is denoted as [symbol] o_{E}. The position of microphone in ear frame [symbol] _{iE} can be calculated from [symbol] _{iB} and transformation matrix ^{E}R_{B} from device frame to the ear frame.

^{B}R_{E}=^{B}R_{Wi}·^{Wi}R_{W}^{W}R_{E}, (62)

[symbol]

_{iE}=^{B}R_{E} [symbol] _{iB}. (63)

The distance from the mouth to the microphone can be obtained by

[symbol]

_{iE}= [symbol] o_{E}− [symbol] _{iE}, (64)

where [symbol] o_{E}= [symbol] _{E}− [symbol] _{E}, is the line vector from the device to the mouth.

Referring again to FIG. 2, the position of mouth in ear frame coordinate system needs to be calibrated in order to guarantee accurate calculation and good performance. VDA module 214 can be first used to grab some speech-only section for the use of mouth location calibration in ADP module 206. Then the distance & angle information calculated from ADP module 206 can be feed back into the VDA module 214 to improve background noise estimation. This iterative method can improve both performances of VAD module 214 and ADP module 206.

The distance from microphone to the mouth [symbol] _{iE} can be feed into MVDR beamformer processor as a priori information to help form a beam towards the corresponding direction. The steering vector for N microphone array can be reformulated as

aₛ(ω)=[1, e^{-jwτ}^{ᵢ} . . . e^{-jwτ}^{_{N}}], (65)

where the acoustic signal delay can be obtained directly from the distance,

$${τ}_{i} = \frac{\vert {\vec{d}}_{iE} \vert}{c} . \qquad ( 66 )$$

Reformulating the Eq. 34 here, we have the stacked vector of microphone array signals as

Y(ω)=[Y₁(ω), . . . Yᵢ(ω), . . . Y_{N}(ω)] (67)

The MVDR filter of interest is denoted as H, thus we have MVDR output signal at specific frequency bin expressed as

$$\begin{matrix}Z ( ω ) = {H}^{H} T ( ω ) \\ = {H}^{H} {a}_{s} ( ω ) S ( ω ) + {H}^{H} V ( ω )\end{matrix} \qquad ( 68 )$$

where S(ω) is the sound-source from the looking direction and V(ω) is the interference and noise.

The MVDR beamformer try to minimize the energy of output signal |Z(ω)|², while to keep the signal from looking direction undistorted in the output. Apparently, according to Eq. 68, this constraint can be formulated as

H^{H}aₛ=1. (69)

Using Eq. 69, the objective function thus can be formulated as

$${min}_{H} {H}^{H} {R}_{VV} ( ω ) H subject to {H}^{H} {a}_{s} = 1 , \qquad ( 70 )$$

where R_{VV}(w) is the correlation matrix of interference and noise.

The optimization problem of equation (70) can be solved as

$${H}_{o , 1} = \frac{{[ {R}_{VV} ( ω ) ]}^{- 1} {a}_{s} ( ω )}{{{a}_{s}^{H} ( ω ) [ {R}_{VV} ( ω ) ]}^{- 1} {a}_{s} ( ω )} , \qquad ( 71 )$$

The equations (46) to (64), and (65) to (71) complete ADP assisted MVDR beamforming processing.

With the method previously described, an alternative coordinate representation that uses a transformation matrix can be used instead of angular and Cartesian coordinates as referred in the earlier sections. The MVDR implementation on both methods is the same, only the coordinate systems differ. In both methods described above, an improvement over conventional MVDR beamformer is that a priori information gathered from the device attitude information is close to the theoretical expected a priori information of the looking direction of the MVDR beamformer.

To control the tradeoff between noise reduction and speech distortion, in some implementations, the weighted sum of noise energy and distortion energy is introduced. The cost function turns to be an unconstraint optimization problem.

$${min}_{H ( ω )} ( {H}^{H} {R}_{V , V} ( ω ) H + λ {\vert {H}^{H} {a}_{s} - 1 \vert}^{2} ) , \qquad ( 72 )$$

which leads to the closed form solution of

$${H}_{O , 2} ( ω ) = \frac{{λ [ {R}_{V , V} ( ω ) ]}^{- 1} {a}_{s} ( ω )}{1 + λ {{a}_{s}^{H} ( ω ) [ {R}_{V , V} ( ω ) ]}^{- 1} {a}_{s} ( ω )} \qquad ( 73 )$$

It is possible to tune λ to control the tradeoff the noise reduction and speech distortion. Note: when γ goes to ∞, we have H_{O,1}(ω)=H_{O,2}(ω).

To limit the amplification of uncorrelated noise components and inherently increase the robustness against microphone mismatch, a WNG constraint can be imposed and the optimization problem becomes

$${min}_{H} {H}^{H} ( ω ) {R}_{V , V} ( ω ) H ( ω ) , \\ subject to \\ {H ( ω )}^{H} {a}_{s} = 1 , \\ {H ( ω )}^{H} H ( ω ) \leq β . \qquad ( 74 )$$

The solution of Eq. 74 can be expressed as

$${H}_{O , 3} ( ω ) = \frac{{[ {R}_{V , V} ( ω ) + μ {I}_{2} ]}^{- 1} {a}_{s} ( ω )}{{{a}_{s}^{H} ( ω ) [ {R}_{V , V} ( ω ) + μ {I}_{2} ]}^{- 1} {a}_{s} ( ω )} , \qquad ( 75 )$$

where μ is chosen such that H_{O,3}(ω)^{H}H_{O,3}(ω)≦β holds.

To conserve the power of mobile device 102, VAD module 214 can turn off one or more modules in speech processing engine 202 when no speech signal is present in the output signals. VAD decision module 612 receives input from pitch and time detector 606 and background noise estimator 614 and uses these inputs, together with the output of module 610 to set a VAD flag. The VAD flag can be used to indicate Voice or Non-Voice, which in turn can be used by system 600 to turn off one or more modules of speech processing engine 202 to conserve power.

### ADP Assisted Automatic Gain Control

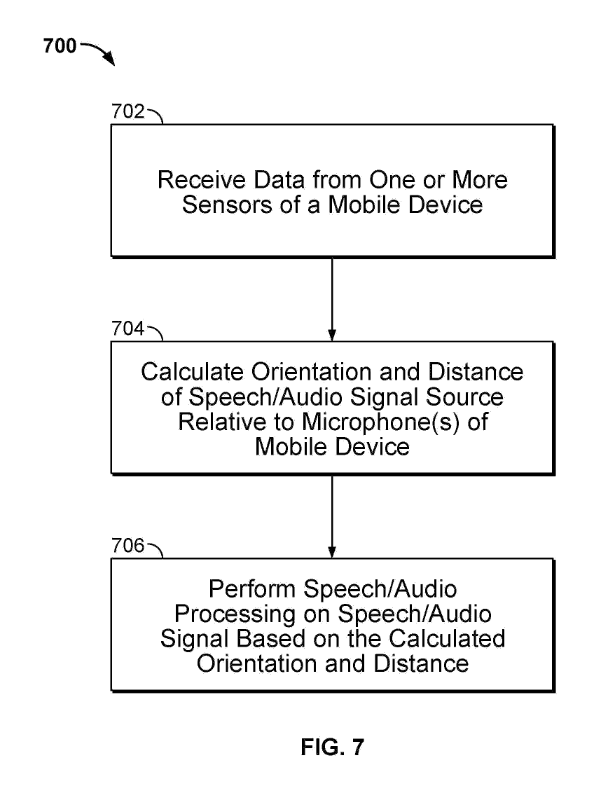

FIG. 7 is a flow diagram of an example process that uses sensor fusion to perform echo and noise cancellation. Process 700 can be performed by one or more processors on mobile device 102. Process 700 can utilize any of the calculations, estimations, and signal-processing techniques previously described to perform echo and noise cancellation. Process 700 will be described in reference to mobile device 102.

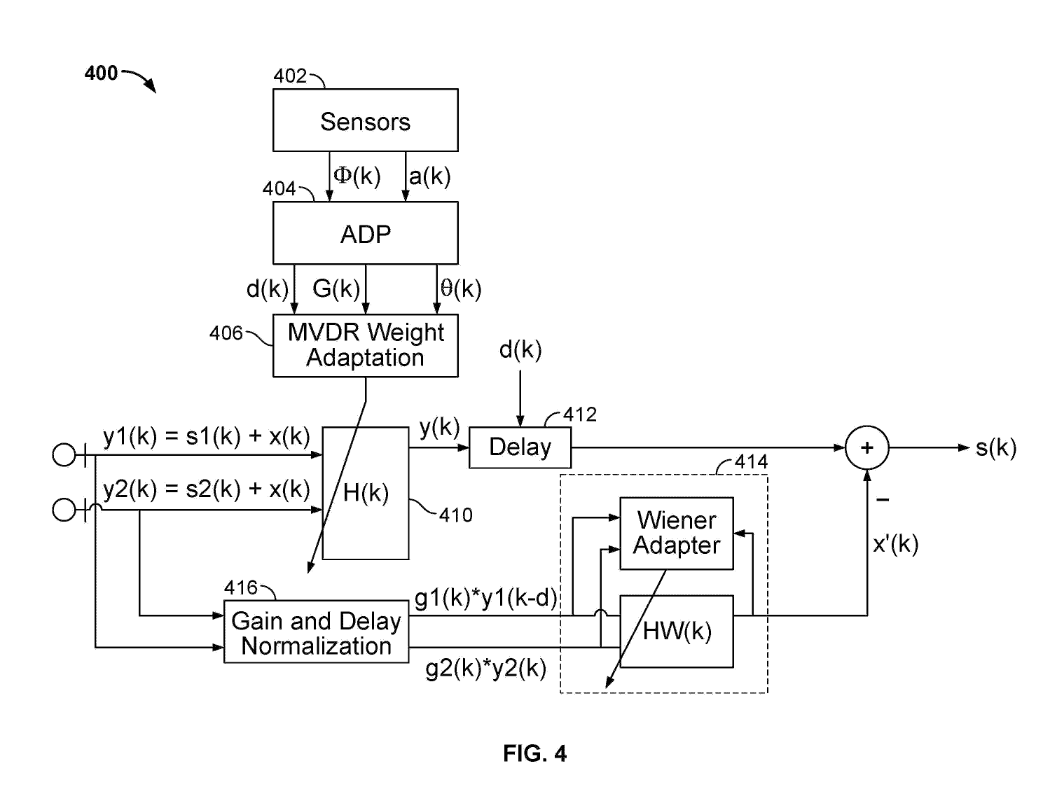

Process 700 can begin when a processor of mobile device 102 receives data from one or more sensors of mobile device 102 (step 702). For example, ADP module 206 can receive sensor output data from sensors 202. Process 700 can calculate an orientation and distance of a speech or other audio signal source relative to one or more microphones of mobile device 102 (step 704). For example, ADP module 206 can employ beamformer techniques combined with sensor outputs from gyros and accelerometers to calculate a distance and incident angle of speech relative to one or more microphones of mobile device 102, as described in reference to FIG. 4.

Process 700 can perform speech or audio processing based on the calculated orientation and distance (step 706). For example, echo and noise cancellation modules 216, 218 in speech processing engine 202 can calculate a gain based on the distance and automatically apply the gain to a first or primary microphone channel signal. Automatically applying the gain to a channel signal can include comparing the calculated gain with an estimated gain, where the estimated gain may be derived from signal processing algorithms and the calculated gain can be obtained from ADP module 206, as described in reference to FIG. 3.

In some implementations, automatic gain control can include calculating a gain error vector ge(k) as the difference between the estimated gains g1′(k), g2′(k) calculated by AGC module 212 from the microphone signals y1(k), y2(k) and the gains g1(k), g2(k) provided by ADP module 206, as described in reference to FIG. 3. Process 700 can use the gain error vector ge(k) to determine whether to use the calculated gains g1(k), g2(k) from ADP 206 or the estimated gains g1′(k), g2′(k) from AGC 212 to normalize the microphone channel signals y1(k), y2(k). For example, if the gain error vector ge(k) exceeds a threshold T, then the estimated gains g1′(k) and g2′(k) can be used to normalize the microphone signals y1(k), y2(k) since a large gain error vector ge(k) indicates that the calculated gains g1(k), g2(k) are not accurate. This could occur, for example, when sensor measurement errors are high due to the operating environment or sensor malfunction.

In some implementations, performing noise cancellation can include automatically tracking a speech signal source received by a microphone based on the estimated angle provided by ADP module 206. The automatic tracking can be performed by a MVDR beamformer system, as described in reference to FIG. 4. Particularly, the MVDR beamformer system 400 can minimize output noise variance while constraining the microphone signal to have unity gain in the direction of the speech signal source or side lobe signals.

In some implementations, process 700 can provide feedback error information to ADP module 206. For example, speech processing engine 202 can track estimated delays and gains to provide error information back to ADP module 206 to improve ADP performance.

### ADP Assisted Double-Talk and Echo Path Changes Separation

Echo cancellation is a primary function of the mobile device 102 signal processing, the echo cancellers purpose is to model and cancel the acoustic signals from the speaker/receiver of the mobile device entering the microphone path of the mobile device. When the far end signal gets picked up from the microphone the echo is generated at the far end and significantly reduce the speech quality and intelligibly. The echo canceller continually models the acoustic coupling from the speaker to microphone. This is achieved by using an Adaptive filter. A NLMS, NLMS, frequency domain NLMS, or sub band NLMS filters are generally used for modeling the acoustic echo path on mobile devices.

When the near end speech is present the echo canceller diverges due to the inherent property of the NLMS algorithm. This problem is known as the double talk divergence of the echo canceller adaptive filter. Conventional echo cancellers address this problem using a double talk detector, which detects double talk based on a correlation of an output signal and microphone input signals. This method can be complex and unreliable. These conventional double talk detectors fail to provide reliable information and to circumvent the problem moderate or mild echo cancellation is used in practice.

Using echo path changes based on output of the ADP module enables the AEC to separate the double talk from echo path changes. When echo path changes are detected based on the movement of the mobile device from the ADP, echo path changing logic can be activated. When the ADP movement detection indicates there is no movement the echo canceller coefficient update can be slowed down so that it does not diverge due to near end double talk.

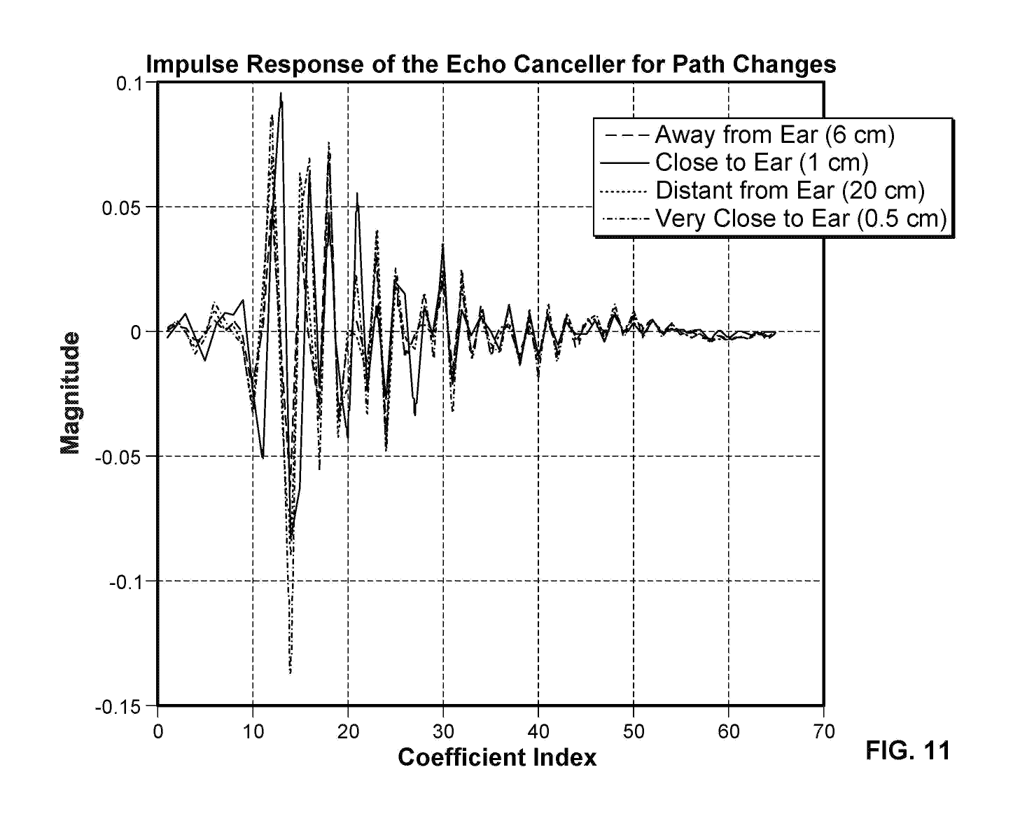

FIG. 11 is a plot illustrating echo path and change of echo path with changes of the position of the mobile device detected by the ADT module. More particularly, FIG. 11 illustrates a typical echo path for a mobile device with changes to the echo path as the user moves the mobile device away from their head. This echo path change and the corresponding ADP information, validates the echo path change and helps adapt to the new echo path.

### Example Device Architecture

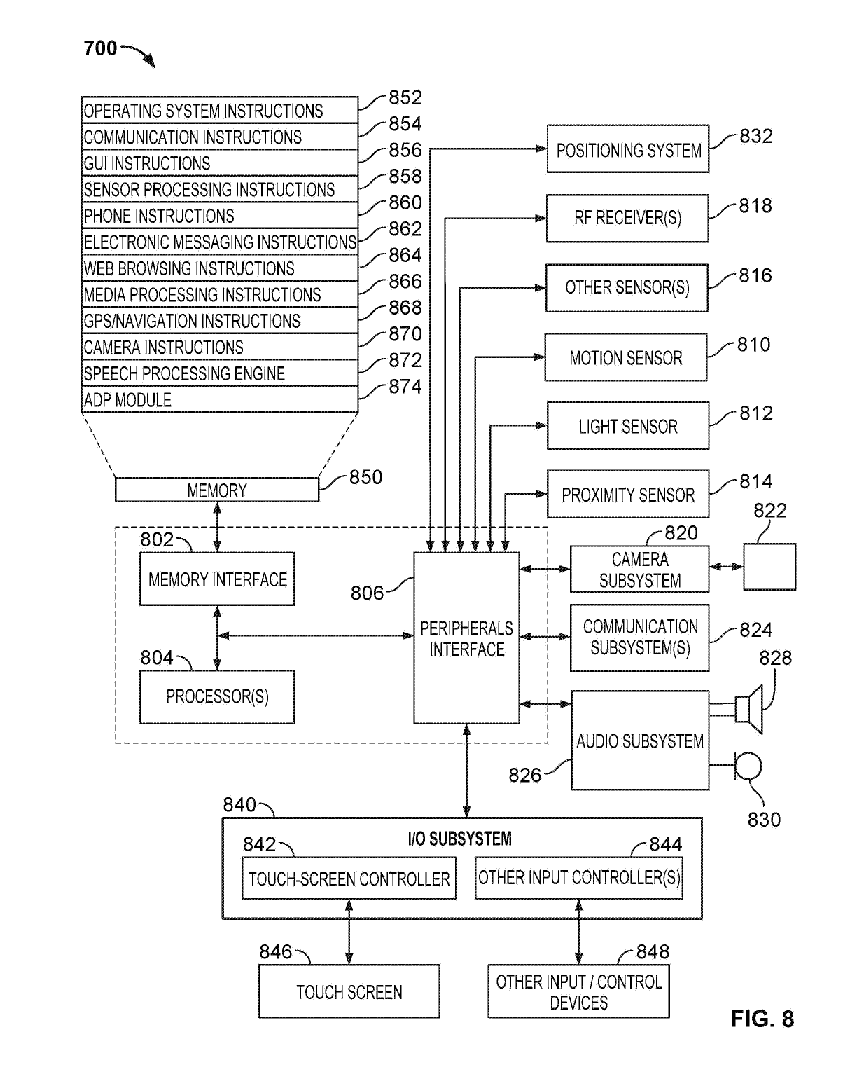

FIG. 8 is a block diagram of an example architecture 800 for a device that employs sensor fusion for improving noise and echo cancellation. Architecture 800 can include memory interface 802, one or more data processors, image processors or central processing units 804, and peripherals interface 806. Memory interface 802, one or more processors 804 or peripherals interface 806 can be separate components or can be integrated in one or more integrated circuits. The various components in device architecture 800 can be coupled by one or more communication buses or signal lines.

Sensors, devices, and subsystems can be coupled to peripherals interface 806 to facilitate multiple functionalities. For example, motion sensor 810, light sensor 812, and proximity sensor 814 can be coupled to peripherals interface 806 to facilitate various orientation, lighting, and proximity functions. For example, in some implementations, light sensor 812 can be utilized to facilitate adjusting the brightness of touch screen 846. In some implementations, motion sensor 810 can be utilized to detect movement of the device. Accordingly, display objects and/or media can be presented according to a detected orientation, e.g., portrait or landscape.

Other sensors 816 can also be connected to peripherals interface 806, such as a temperature sensor, a biometric sensor, or other sensing device, to facilitate related functionalities. For example, device architecture 800 can receive positioning information from positioning system 832. Positioning system 832, in various implementations, can be a component internal to device architecture 800, or can be an external component coupled to device architecture 800 (e.g., using a wired connection or a wireless connection). In some implementations, positioning system 832 can include a GPS receiver and a positioning engine operable to derive positioning information from received GPS satellite signals. In other implementations, positioning system 832 can include a magnetometer, a gyroscope (“gyro”), a proximity switch and an accelerometer, as well as a positioning engine operable to derive positioning information based on dead reckoning techniques. In still further implementations, positioning system 832 can use wireless signals (e.g., cellular signals, IEEE 802.11 signals) to determine location information associated with the device.

Broadcast reception functions can be facilitated through one or more radio frequency (RF) receiver(s) 818. An RF receiver can receive, for example, AM/FM broadcasts or satellite broadcasts (e.g., XM® or Sirius® radio broadcast). An RF receiver can also be a TV tuner. In some implementations, RF receiver 818 is built into wireless communication subsystems 824. In other implementations, RF receiver 818 is an independent subsystem coupled to device architecture 800 (e.g., using a wired connection or a wireless connection). RF receiver 818 can receive simulcasts. In some implementations, RF receiver 818 can include a Radio Data System (RDS) processor, which can process broadcast content and simulcast data (e.g., RDS data). In some implementations, RF receiver 818 can be digitally tuned to receive broadcasts at various frequencies. In addition, RF receiver 818 can include a scanning function, which tunes up or down and pauses at a next frequency where broadcast content is available.

Camera subsystem 820 and optical sensor 822, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 824. Communication subsystem(s) can include one or more wireless communication subsystems and one or more wired communication subsystems. Wireless communication subsystems can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving and/or transmitting data. The specific design and implementation of communication subsystem 824 can depend on the communication network(s) or medium(s) over which device architecture 800 is intended to operate. For example, device architecture 800 may include wireless communication subsystems designed to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. Communication subsystems 824 may include hosting protocols such that Device architecture 800 may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 826 can be coupled to speaker 828 and one or more microphones 830 to facilitate voice-enabled functions, such as voice recognition, voice replication, digital recording, and telephony functions Audio subsystem 826 can also include a codec (e.g., AMR codec) for encoding and decoding signals received by one or more microphones 830, as described in reference to FIG. 2.

I/O subsystem 840 can include touch screen controller 842 and/or other input controller(s) 844. Touch-screen controller 842 can be coupled to touch screen 846. Touch screen 846 and touch screen controller 842 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch screen 846 or proximity to touch screen 846.

Other input controller(s) 844 can be coupled to other input/control devices 848, such as one or more buttons, rocker switches, thumb-wheel, infrared port, USB port, and/or a pointer device such as a stylus. The one or more buttons (not shown) can include an up/down button for volume control of speaker 828 and/or microphone 830.

In one implementation, a pressing of the button for a first duration may disengage a lock of touch screen 846; and a pressing of the button for a second duration that is longer than the first duration may turn power to device architecture 800 on or off. The user may be able to customize a functionality of one or more of the buttons. Touch screen 846 can, for example, also be used to implement virtual or soft buttons and/or a keyboard.

In some implementations, device architecture 800 can present recorded audio and/or video files, such as MP3, AAC, and MPEG files. In some implementations, device architecture 800 can include the functionality of an MP3 player.

Memory interface 802 can be coupled to memory 850. Memory 850 can include high-speed random access memory and/or non-volatile memory, such as one or more magnetic disk storage devices, one or more optical storage devices, and/or flash memory (e.g., NAND, NOR). Memory 850 can store operating system 852, such as Darwin, RTXC, LINUX, UNIX, OS X, WINDOWS, or an embedded operating system such as VxWorks. Operating system 852 may include instructions for handling basic system services and for performing hardware dependent tasks. In some implementations, operating system 852 can be a kernel (e.g., UNIX kernel).

Memory 850 may also store communication instructions 854 to facilitate communicating with one or more additional devices, one or more computers and/or one or more servers. Communication instructions 854 can also be used to select an operational mode or communication medium for use by the device, based on a geographic location (obtained by GPS/Navigation instructions 868) of the device. Memory 850 may include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic-messaging related processes and functions; web browsing instructions 864 to facilitate web browsing-related processes and functions; media processing instructions 866 to facilitate media processing-related processes and functions; GPS/Navigation instructions 868 to facilitate GPS and navigation-related processes and instructions, e.g., mapping a target location; camera instructions 870 to facilitate camera-related processes and functions; software instructions 872 for implementing modules in speech processing engine 202 and instructions 874 for implementing the ADP module 206, as described in FIGS. 2-4. In some implementations, media processing instructions 866 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. Memory 850 can include additional instructions or fewer instructions. Furthermore, various functions of device architecture 800 may be implemented in hardware and/or in software, including in one or more signal processing and/or application specific integrated circuits.

The features described can be implemented in digital electronic circuitry, or in computer hardware, firmware, software, or in combinations of them. The features can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an Application Programming Interface (API). An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method performed by one or more processors of a mobile device, comprising:
receiving data from one or more sensors of a mobile device;
calculating an orientation and distance of a signal source relative to a first microphone of the mobile device based on the data;
receiving a signal from the source through the first microphone; and
processing the signal based on the calculated orientation and distance.

2. The method of claim 1, where processing comprises:
calculating a gain based on the distance; and
automatically applying the gain to the signal received through the first microphone.

3. The method of claim 2, where automatically applying the gain, comprises:
comparing the calculated gain with an estimated gain; and
determining whether to apply the calculated gain to the signal based on results of the comparison.

4. The method of claim 3, where processing comprises:
determining a gain error based on the calculated gain and the estimated gain; and
applying either the calculated gain or the estimated gain to the signal received through the first microphone based on the gain error.

5. The method of claim 1, where processing comprises:
automatically tracking the source of the signal received through the first microphone using the calculated orientation and distance.

6. The method of claim 5, where the tracking is performed by a Minimum Variance Distortionless Response (MVDR) beamformer.

7. The method of claim 1, where processing comprises:
selecting coefficients of an adaptive filter of an echo canceller based on the orientation or distance.

8. The method of claim 1, further comprising:
estimating a delay between receipt of the signal at the first microphone and receipt of the signal at a second microphone of the mobile device, the second microphone having a fixed orientation and distance relative to the first microphone.

9. The method of claim 8, further comprising:
detecting whether the signal includes speech based on the estimated delay.

10. The method of claim 8, further comprising:
aligning signals received through the first and second microphones in time using the estimated delay;
estimating noise on the aligned signals; and
canceling noise from a combined signal using the estimated noise, where the combined signal includes the signals received through the first and second microphones.

11. A computer-implemented method performed by one or more processors of a mobile device, comprising:
receiving sensor data;
computing an angle and distance from the sensor data, the angle defining a relative orientation of a speech signal source and a microphone of the mobile device, the distance defining a distance between the speech signal source and the microphone;
receiving a speech signal from the speech signal source through the microphone; and
performing at least one of noise cancellation, echo cancellation, voice activity detection, switching from handset to speakerphone mode, or automatic gain control based on the angle.

12. A system comprising:
a first microphone;
a sensor configured for providing sensor output data in response to a change of position of the system;
a processor coupled to the sensor and the first microphone and programmed for:
receiving data from one or more sensors of a mobile device;
calculating an orientation and distance of a signal source relative to a first microphone of the mobile device based on the data;
receiving a signal from the source through the first microphone; and
processing the signal based on the calculated orientation and distance.

13. The system of claim 12, where the processor is programmed for:
calculating a gain based on the distance; and
automatically applying the gain to the signal received through the first microphone.

14. The system of claim 13, where automatically applying the gain, comprises:
comparing the calculated gain with an estimated gain; and
determining whether to apply the calculated gain to the signal based on results of the comparison.

15. The system of claim 12, where the processor is programmed for:
determining a gain error based on the calculated gain and the estimated gain; and
applying either the calculated gain or the estimated gain to the signal received through the first microphone based on the gain error.

16. The system of claim 12, where the processor is programmed for:
automatically tracking the source of the signal received through the first microphone using the calculated orientation and distance.

17. The system of claim 16, where the tracking is performed by a Minimum Variance Distortionless Response (MVDR) beamformer.

18. The system of claim 12, where the processor is programmed for:
selecting coefficients of an adaptive filter of an echo canceller based on the orientation or distance.

19. The system of claim 12, where the processor is programmed for:
estimating a delay between receipt of the signal at the first microphone and receipt of the signal at a second microphone of the mobile device, the second microphone having a fixed orientation and distance relative to the first microphone.

20. The system of claim 19, where the processor is further programmed for:
detecting whether the signal includes speech based on the estimated delay.

21. The system of claim 19, where the processor is further programmed for:
aligning signals received through the first and second microphones in time using the estimated delay;
estimating noise on the aligned signals; and
canceling noise from a combined signal using the estimated noise, where the combined signal includes the signals received through the first and second microphones.

22. A mobile device comprising:
one or more sensors configured to generate data in response to motion of the mobile device;
one or more microphones;
one or more processors coupled to the one or more sensors and the one or more microphones and programmed for:
receiving data from the sensor;
calculating an orientation and distance of a signal source relative to the one or more microphones based on the sensor data;
receiving a signal from the source through at least one microphone; and
processing the signal based on the calculated orientation and distance.

23. The mobile device of claim 22, where processing includes performing at least one of noise cancellation, echo cancellation, voice activity detection, switching from handset to speakerphone mode, or automatic gain control based on the orientation or distance.
